(19) United States
(12) Patent Application Publication
(10) Pub. No.: US 2022/0327538 A1
(43) Pub. Date: Oct. 13, 2022

(54) SYSTEM AND METHOD FOR COLLECTING AND STORING ENVIRONMENTAL DATA IN A DIGITAL TRUST MODEL AND FOR DETERMINING EMISSIONS DATA THEREFROM

(71) Applicant: KPMG LLP, New York, NY (US)

(72) Inventors: Venki Kumar, Boston, MA (US); Arun Ghosh, Lexington, MA (US); Tegan Keele, Costa Mesa, CA (US); Ashley Niketas, Birmingham, AL (US); Ryan Maloney, Mahopac, NY (US); Soumya Shetty, San Francisco, CA (US); Steven K. Rainey, Vienna, VA (US)

(21) Appl. No.: 17/849,412

(22) Filed: Jun. 24, 2022

Related U.S. Application Data
(63) Continuation-in-part of application No. 17/239,420, filed on Apr. 23, 2021.
Application No. 17/239,420 is a continuation-in-part of application No. 17/408,861, filed on Aug. 23, 2021.
Application No. 17/408,861 is a continuation of application No. 17/077,593, filed on Oct. 22, 2020, now Pat. No. 11,100,502.
Application No. 17/077,593 is a division of application No. 16/881,157, filed on May 22, 2020, now Pat. No. 11,100,501.
(60) Provisional application No. 63/215,391, filed on Jun. 25, 2021.
(60) Provisional application No. 63/087,721, filed on Oct. 5, 2020.
(60) Provisional application No. 63/015,135, filed on Apr. 24, 2020.
(60) Provisional application No. 63/215,442, filed on Jun. 26, 2021.

(51) Int. Cl. G06Q 20/40; H04L 9/32

(52) U.S. Cl. CPC G06Q 20/401; H04L 9/3263; H04L 9/3236; G06Q 2220/12; H04L 2209/56; H04L 9/50

(57) ABSTRACT

A system and method for monitoring and assessing the carbon footprint of an enterprise. The system aggregates data, such as for example environmental data, enriches the data and then stores the data along with additional information in a blockchain. The additional information stored in the blockchain can include third party data, the types of risk models and machine learning techniques employed by the system, emissions data, attribute data, and the like.

### RELATED APPLICATIONS

The present application claims priority to U.S. provisional patent application Ser. No. 63/215,391, filed on Jun. 25, 2021, and entitled System And Method For Collecting And Storing Environmental Data In A Digital Trust Model And For Determining Emissions Data Therefrom, and U.S. provisional patent application Ser. No. 63/215,442, filed on Jun. 26, 2021, and entitled System And Method For Collecting And Storing Environmental Data In A Digital Trust Model And For Determining Emissions Data Therefrom, and is a continuation-in part patent application of U.S. patent application Ser. No. 17/239,420, filed on Apr. 23, 2021, and entitled System And Method For Collecting And Storing Environmental Data In A Digital Trust Model, And Processing The Data Using An Accounting Infrastructure, which claims the benefit of U.S. provisional patent application Ser. No. 63/087,721, filed Oct. 5, 2020, and U.S. provisional patent application Ser. No. 63/015,135, filed Apr. 24, 2020, and is also a continuation-in-part patent application of U.S. patent application Ser. No. 17/408,861, filed on Aug. 23, 2021, and entitled Modular, Configurable Smart Contracts For Blockchain Transactions, which is a continuation of U.S. patent application Ser. No. 17/077,593, filed Oct. 22, 2020, and now U.S. Pat. No. 11,100,502, which in turn is a divisional application of U.S. patent application Ser. No. 16/881,157, filed on May 22, 2020, now U.S. Pat. No. 11,100,501, where the contents of all of the foregoing applications and patents are herein incorporated by reference.

### BACKGROUND OF THE INVENTION

Today more than ever, there is enhanced focus on the environment and the impact that humans are having thereon. There has been an ever growing body of scientific research and data indicating that humans are having a dramatic impact on the climate of the Earth, and unfortunately are changing the climate for the worse. Climate change typically occurs when changes in Earth's overall climate system result in new weather patterns that remain in place for extended periods of time. The climate system of the Earth is related to the amount of energy entering the overall climate system, such as from the Sun and green-house gas emissions, and the total amount of energy leaving the system, such as into space. Today, the amount of energy being retained in the climate system continues to increase, thus leading to an overall increase in the temperature of the Earth.

The Earth's climate is one of the few aspects of life that are shared universally amongst humans. In the midst of increasingly severe and frequent climate impacts, governments and enterprises alike are becoming increasingly aligned regarding the need to manage climate change by reducing global green-house gas emissions across private and public sectors. Moreover, climate change has become a ubiquitous factor in our overall human experience. Global experts are virtually unified in agreement that urgent action needs to be taken to reduce emissions in order to help manage the overall impacts on the environment.

Prior actions taken on behalf of governments, enterprises such as companies, and individuals have resulted in increased awareness of the carbon foot-print associated with everyday activities. This awareness has led some enterprises to put efforts in place to measure their carbon emissions in order to monitor and even improve upon their current footprint. Both enterprises and individuals can, if needed, buy and sell carbon “offsets” for these emissions. However, to date, there has not been an overall system in place that allows people to readily track environmental information or data associated with specific activities with a high degree of confidence and in a trusted and verifiable manner. That is, although the environmental data can be collected, it is typically not secured in an immutable format and hence can be subjected to unwanted changes and manipulations. As such, it has been difficult to rely on the collected environmental information when making long term plans and overall decisions based on the data.

One such scenario involves the ability to utilize the environmental data in a financial environment, such as for example in a tax, audit, accounting or consulting environment, by enterprises when advising clients about long term financial and business strategies. Unfortunately, current building management systems do not secure the environmental data in an immutable and trusted manner for subsequent verification. Further, the unsecured nature of the environmental data makes it difficult for the financial entities to rely on the data when performing standard financial activities on behalf of their clients, such as for example advising the clients on overall business strategy.

### SUMMARY OF THE INVENTION

The present invention is directed to monitoring and assessing the entire carbon chain or footprint of an enterprise from source to recycle or reuse. The entire carbon chain or footprint of the enterprise includes for example tracking, monitoring and assessing the carbon usage or generation associated with the raw materials that are sourced for making for example a device or a building or equipment, the activities associated with transporting the raw materials to a processing or production location, the processing of the raw materials, the activities associated with assembling or manufacturing the designed product, the activities associated with the storing, distributing, and the selling of the product to customers including the enterprise, and customers using the product. The carbon chain also includes activities associated with the enterprise (e.g., customer), such as operating their facilities, the reuse or recycling of emissions or materials, and the like.

The present invention is directed to a data collection and processing system that aggregates data, such as for example environmental data, financial data, and non-financial data, and then stores the data along with additional information in an immutable and trusted manner, such as for example by employing blockchain technology. The additional information stored in the blockchain can include third party data, the types of risk models and machine learning techniques employed by the system, emissions data, attribute data, and the like. Specifically, the environmental data including emission data, the enriched data, the machine learning models and techniques applied to the data, and the insights and conclusions generated by the enrichment unit can be stored in a blockchain of a digital trust infrastructure unit, thus enabling the system to cryptographically verify and store the logic and structure applied to the data so as to curate the data. The stored and verifiable data can also be used for subsequent reporting and analysis.

The present invention is directed to a data collection and processing system comprising a plurality of data sources for generating environmental data and a data analysis module for receiving the environmental data from the plurality of data sources. The data analysis module includes an enrichment unit for storing and enriching the environmental data from the plurality of data sources to form enriched environmental data. The enrichment unit includes a financial subsystem for analyzing and processing the environmental data and for generating financial data and non-financial data therefrom. The data analysis module also includes a digital trust infrastructure unit for storing the financial data and the non-financial data, where the enriched environmental data or the environmental data is stored in the data layer in a secure and verifiable format. The system also includes a post-processing unit for processing the environmental data and the financial data stored in the digital trust infrastructure so as to generate one or more reports from the environmental data and the financial data.

The data sources include a plurality of measuring devices coupled to one or more structures for measuring one or more selected parameters including one or more of power generation, power consumption, humidity, occupancy, and emissions of various fluids and gases, to form the environmental data. The data sources can also include pre-stored data including data from data libraries related to the parameters being measured by the measurement devices. The environmental data and associated attribute data can be scored and then ranked, and then the resulting ranked environmental data can be normalized. The environmental data can be normalized by applying thereto standards data from one or more related or relevant standards and regulation data from one or more related or relevant regulations.

The data collection and processing system of the present invention can also be employed by many different types of enterprises across many different types of business sectors that have a need or desire to employ environmental data, as well as other types of data, to reduce the overall carbon footprint of the business operations, lower operational costs, and mitigate climate-related physical and transitional risks that impact the financial performance of the business. Further, the system of the present invention enables businesses to integrate environmental data to assess the quality of assets, such as property assets, measure the overall climate exposure of the asset, and advise businesses on the financial risks associated with the asset.

The data collection and processing system of the present invention integrates different technologies in a cloud based manner to collect environmental data from various data sources and thus form the backbone of an environmental accounting infrastructure. The system can process, enrich, store, audit and authenticate the environmental data in a highly automated manner. The cognitive intelligence unit of the data analysis module can derive granular insights and help enterprises make predictions for how best to optimize resources or manage portions of or the entire emissions or carbon footprint of the enterprise, so as to help mitigate the overall environmental impact of the enterprise. The reporting functions of the post-processing unit and the financial verification unit can allow the attestation body (e.g., accounting firm) to attest and certify environmental related disclosures for financial and non-financial reporting and compliance within the context of standard accounting frameworks.

Further, the environmental financial system implemented by the data collection and processing system allows enterprises to measure, manage, and reduce carbon emissions and help trace the energy supply and demand pipeline. The environmental data accumulated by the system can be integrated with a high degree of confidence and trust into the financial analysis. The system can also help selected attestation bodies track and account for carbon emissions and carbon removal (e.g., credits and debits) transparently and accurately. The attestation bodies can harness the accounting infrastructure of the system to help clients understand the impact of climate risks on asset valuations, business operations, and financial performance.

The data collection and processing system of the present invention can also be used by the enterprise to align together, and to consider in coordination with other factors, the climate strategy and goals of the enterprise, the impact on the enterprise of climate risks, such as those associated with manufacturing and infrastructure, and the overall investment strategy of the enterprise, including the use or employment of renewable assets and the like. These factors enable the enterprise to determine the proper areas for investment, whether through carbon offsets or credits, the utilization of renewable resources, the retrofitting of equipment, and the like.

The present invention is directed to a data collection and processing system comprising a plurality of data sources for generating environmental data from one or more enterprises, and a data analysis module for receiving the environmental data from the plurality of data sources. The data analysis module includes an enrichment unit for storing and enriching the environmental data from the plurality of data sources to form enriched environmental data, wherein the enrichment unit includes a financial subsystem for analyzing and processing the environmental data and for generating financial data and non-financial data therefrom, and a digital trust infrastructure unit for storing the financial data and the non-financial data, the enriched environmental data or the environmental data is stored in the data layer in a secure and verifiable format. The digital trust infrastructure unit employs a blockchain for storing any combination of the environmental data, the enriched environmental data, and the financial data. The system also includes a post-processing unit for processing the environmental data and the financial data stored in the digital trust infrastructure so as to generate one or more reports from the environmental data and the financial data. Further, the plurality of data sources includes a plurality of devices coupled to one or more structures of the enterprise for measuring one or more selected parameters thereof to form the environmental data, and pre-stored data including data from data libraries related to the parameters being measured by the plurality of devices. The enrichment unit includes a data layer for storing the environmental data from the plurality of data sources. The data layer includes a partition unit for virtually segmenting the enterprise into a plurality of clusters where each of the plurality of clusters has associated therewith one or more of the plurality of devices for generating the environmental data, and a normalization unit for normalizing the environmental data from the plurality of devices for each of the plurality of clusters. The system further includes an applications interface unit having an application unit for storing one or more software applications for processing the environmental data in the data layer, and a third party data unit for storing third party data that is related to the environmental data stored in the data layer. A cognitive intelligence unit is also provided for applying one or more pre-defined intelligence techniques to the environmental data so as to process and enrich the environmental data to form the enriched environmental data. The cognitive intelligence unit includes a recommendation engine for applying a machine learning technique to the environmental data from the data layer to generate predictions based on the environmental data.

The devices are configured to generate the environmental data and includes one or more attributes associated therewith. The devices can include, for example, one or more sensors. The partition unit comprises a scoring unit for determining based on the environmental data generated by the devices a data attribute score associated with each device, where the data attribute score corresponds to the number of attributes associated with each device, and a ranking unit for ranking the devices based on the data attribute score. The ranking unit is configured to rank the devices based on a reliability of the device. According to one practice, the ranking unit is configured to check the reliability of the device by analyzing output data of the devices over a selected period of time and by comparing the output data to a preselected device output data range. The ranking unit is also configured to determine the reliability of the device based on the output data generated by one or more additional devices.

According to one embodiment, the plurality of data sources correspond to a plurality of devices arranged in a device network, and the ranking unit is configured to arrange each of the plurality of devices into a plurality of logical tiers based on the number of physical connections to the remaining devices in the device network. The normalization unit can be configured to contextualize the environmental data associated with one or more clusters of the enterprise or one or more portions of one or more clusters of the enterprise. The normalization unit is also configured to compare the environmental data from one of the plurality of clusters with one or more other clusters of the plurality of clusters employing similar devices. According to one practice, the normalization unit comprises a standards module for applying to the environmental data one or more rules associated with one or more standards associated with the environmental data so as to generate standards data, wherein the standards module applies the standard to the environmental data so as to estimate an emissions footprint of one or more clusters of the plurality of clusters, and a regulations module for applying to the environmental data one or more rules associated with a selected framework that is associated with the environmental data being processed by the normalization unit so as to produce regulation data. The standards module is configured when applying the rules to the environmental data to determine an emissions footprint of the enterprise.

The pre-defined intelligence techniques include one or more of a machine learning technique, an artificial intelligence technique, a natural language processing technique, neural networks, statistical techniques, and a risk modelling technique. The third party data comprises one or more of weather data, occupancy data, satellite data, optical data, physical enterprise data, maintenance related data, equipment related data, spatial related data associated with structures, enterprise data, and asset management related data.

The cognitive intelligence unit further comprises a risk model unit for applying one or more risk modelling techniques to the environmental data from the data layer. The risk model unit and the recommendation engine consume the enriched environmental data that is stored in the digital trust infrastructure unit. The digital trust infrastructure unit employs a blockchain for storing the enriched environmental data. The post-processing unit includes one or more software applications for processing and integrating the enriched environmental data stored in the blockchain to generate one or more reports from the enriched environmental data. The post-processing unit further comprises a data visualization software application for analyzing the enriched environmental data and then displaying the data in a graph-type visualization format.

The system of the present invention further includes a token creation unit for creating one or more tokens from the environmental data or the enriched environmental data collected from a plurality of measuring devices or the enriched environmental data or data provided by a third party to form one or more financial derivatives, wherein the financial derivatives can include one or more of a carbon credit, a renewable energy credit, an emissions reduction credit, and a carbon offset; an attestation unit for verifying the environmental data forming the one or more tokens or the one or more tokens and for generating attestation data associated therewith, wherein the attestation data provides for a verification of the validity of the environmental data; and a predictive analytics unit for analyzing the environmental data forming the one or more tokens and for providing predictions based on the environmental data. The post-processing unit further comprises one or more of an emissions accounting unit for processing the enriched environmental data to provide one or more reports related to tracking and determining emissions of an enterprise; an emissions management unit for processing the enriched environmental data to manage the emissions of the enterprise; an emissions reporting unit for processing the enriched environmental data to generate one or more reports directed to an emissions profile of the enterprise; an emissions trading unit for processing the enriched environmental data to provide information relating to trading of one or more emission related credits between enterprises; a risk management unit for processing the enriched environmental data to determine and manage a financial risk or a non-financial risk to the enterprise based on the environmental data; and a governance reporting unit for processing the enriched environmental data and generating based thereon a report directed to a governance profile of the enterprise.

The emissions accounting unit determines the emissions of the enterprise or building or infrastructure and determines and tracks energy consumption of the enterprise based on the enriched environmental data. The emissions management unit determines overall energy consumption of the enterprise and based on the enriched environmental data procures energy and one or more other utilities including water for the enterprise. The emissions reporting unit generates one or more reports based on climate data and the enriched environmental data to certify the accuracy of the emissions of the enterprise based on the emissions determined by the emissions accounting unit, the overall energy consumption determined by the emissions management unit, and one or more tokens created by a token creation unit from the environmental data collected from a plurality of measuring devices. The emissions trading unit is configured to determine a carbon allowance associated with the enterprise and to track and certify any tokenized carbon credits or renewable energy certificates or emissions reduction credits associated with the emission offsets of the enterprise.

The present invention is also directed to a computer-implemented method for collecting and processing data comprising generating environmental data from a plurality of data sources and providing a data analysis module for receiving the environmental data from the plurality of data sources. The data analysis module includes an enrichment unit for storing and enriching the environmental data from the plurality of data sources, wherein the enrichment unit includes a financial subsystem for analyzing and processing the environmental data and for generating financial data therefrom, and a digital trust infrastructure unit for storing the financial data, the enriched environmental data or the environmental data stored in the data layer in a secure and verifiable format. The method includes processing the environmental data and the financial data stored in the digital trust infrastructure with a post-processing unit so as to generate one or more reports from the environmental data and the financial data. The enrichment layer is configured for storing the environmental data from the plurality of data sources in a data layer. The data layer is configured for virtually segmenting the enterprise into a plurality of clusters with a partition unit, wherein each of the plurality of clusters has associated therewith one or more of the plurality of data sources for generating the environmental data, and normalizing the environmental data from the plurality of data sources for each of the plurality of clusters with a normalization unit. The method also includes storing one or more software applications for processing the environmental data in the data layer in an application unit, storing third party data that is related to the environmental data stored in the data layer in a third party data unit, and applying one or more pre-defined techniques to the environmental data so as to process the environmental data in a cognitive intelligence unit.

According to one embodiment, each of the plurality of clusters has one or more devices associated therewith, and the one or more devices are configured to generate the environmental data and has one or more attributes associated therewith. The device can include one or more sensors. Further, the step of virtually segmenting the enterprise comprises determining based on the environmental data generated by the one or more devices a data attribute score associated with each device, wherein the data attribute score corresponds to the number of attributes associated with each device, and ranking the devices based on the data attribute score. According to the present invention, ranking the devices further comprises ranking the devices based on a reliability of the device, as well as optionally checking the reliability of the device by analyzing output data of the devices over a selected period of time and by comparing the output data to a preselected device output data range. The method can also include determining the reliability of the device based on the output data generated by one or more additional devices. The plurality of data sources corresponds to a plurality of devices arranged in a device network, and ranking the devices further comprises arranging each of the plurality of devices into a plurality of logical tiers based on a number of connections to the remaining devices in the device network.

According to one embodiment. The method includes normalizing the environmental data by contextualizing the environmental data associated with one or more clusters of the enterprise or one or more portions of one or more clusters of the enterprise. The method can also normalize the environmental data by comparing the environmental data from one of the plurality of clusters with one or more other clusters of the plurality of clusters employing similar devices.

According to another practice, normalizing the environmental data comprises applying to the environmental data one or more rules associated with one or more standards associated with the environmental data so as to generate standards data, wherein the standards module applies the standard to the environmental data so as to estimate an emissions footprint of one or more clusters of the plurality of clusters, and applying to the environmental data one or more rules associated with a selected framework that is associated with the environmental data being processed by the normalization unit so as to produce regulation data. The method can further include applying the standard to the environmental data to determine the emissions footprint of the total enterprise.

Further, each of the plurality of clusters has one or more devices associated therewith and the devices are configured to generate the environmental data and include one or more attributes associated therewith. The method can include determining an inventory of all of the devices in one or more of the plurality of clusters that are generating emissions, verifying the environmental data from the devices using the attributes, determining based on the environmental data generated by the one or more devices a data attribute score associated with each device, wherein the data attribute score corresponds to the number of attributes associated with each device, ranking the devices and associated environmental data based on the data attribute score, and normalizing the environmental data by contextualizing the environmental data associated with one or more clusters of the enterprise or one or more portions of one or more clusters of the enterprise. Further, the method can optionally include scoring the environmental data from one or more of the clusters by determining the number of attributes available in the cluster, ranking the devices and associated environmental data based on the scoring, estimating the emissions of one or more of the clusters of the enterprise, recording non-environmental data and associated attribute data generated by one or more of the devices, and verifying the non-environmental data with the attribute data. The method can further include estimating the emissions of the cluster using the verified environmental data and the verified non-environmental data to form estimated emissions data, normalizing the estimated emissions data by applying one or more of standards data associated with one or more standards and regulations data associated with one or more regulations to produce normalized emissions data, allocating the normalized emissions data to one or more clusters of the enterprise enterprises or to one or more enterprises, and determining the total emissions data associated with a first enterprise.

According to one embodiment, the method includes providing a smart contract stored in the digital trust infrastructure unit that is configured to estimate the emissions of the cluster using the verified environmental data and the verified non-environmental data to form estimated emissions data, normalize the estimated emissions data by applying thereto one or more of standards data associated with one or more standards and regulations data associated with one or more regulations to produce normalized emissions data, allocate the normalized emissions data to one or more clusters of the enterprise enterprises or to one or more enterprises, and determine the total emissions data associated with a first enterprise.

The method can also include determining a net impact of a climate action taken by the first enterprise in response to the total emissions data, wherein each climate action has attribute data associated therewith, recording the environmental data associated with each climate action taken by the first enterprise, processing and recording the attribute data associated with each device and each climate action performed so as to verify the environmental data of each climate action of the first enterprise, scoring the environmental data by determining a number of attributes forming the attribute data available in the first enterprise, ranking the devices and the associated environmental information in the first enterprise based on the scoring of the attribute data for each climate action performed by the first enterprise, recording non-environmental data and associated attribute data associated with each of the climate actions, verifying the non-environmental data with the attribute data, estimating a climate impact of the climate actions taken by the first enterprise based on the environmental data and the non-environmental data to generate estimated climate impact data, normalizing the estimated climate impact data by applying thereto one or more of standards data associated with one or more standards and regulations data associated with one or more regulations to produce normalized climate impact data, determining one or more financial and non-financial metrics associated with the normalized climate impact data for the first enterprise, allocating the normalized climate impact data, and estimating a nest impact of the climate actions taken by the first enterprise.

The post-processing unit further comprises one or more of an emissions accounting unit for processing the enriched environmental data to provide one or more reports related to tracking and determining emissions of an enterprise; an emissions management unit for processing the enriched environmental data to manage the emissions of the enterprise; an emissions reporting unit for processing the enriched environmental data to generate one or more reports directed to an emissions profile of the enterprise; an emissions trading unit for processing the enriched environmental data to provide information or reports related to trading of one or more emission related credits between enterprises; a risk management unit for processing the enriched environmental data to determine and manage a financial risk to the enterprise based on the environmental data; and a governance reporting unit for processing the enriched environmental data and generating based thereon a report directed to a governance profile of the enterprise.

According to another embodiment, the method can include recording a current status of a blockchain-implemented ledger using a modular smart contract, and then optionally one or more of receiving, by a processing device, one or more new data object attributes and attribute values for an object key; identifying, by the processing device, a data object matching the object key in the blockchain-implemented ledger; storing, by the processing device executing a first modular contract from a transaction log partition of the block-chain implemented ledger, a first version of the data object associated with the object key in the block-chain implemented ledger, wherein the data object has a first version number and includes a first set of data object attributes and attribute values; calling, by the processing device executing the first modular smart contract, a second smart contract from a validation data partition of the blockchain implemented ledger; creating, by the processing device executing the second smart contract, a second version of the data object that is associated with the object key and that has a second version number; importing, by the processing device executing the second smart contract, the first set of data object attributes and attribute values into the second version of the data object; validating, by the processing device executing the second smart contract, the one or more new data object attributes and attribute values by retrieving validation rules from the validation data partition, applying the validation rules to a hierarchy associated with the one or more new data object attributes and attribute values, and determining that the hierarchy associated with the one or more new data object attributes and attribute values satisfies the validation rules; submitting, by the processing device executing the second smart contract, the second version of the data object to the blockchain-implemented ledger that references the object key; recording, by the processing device, a snapshot of the blockchain-implemented ledger holding the second version of the data object in a world state database; and simultaneously retaining by the processing device, the first version of the data object and the second version of the data object in the blockchain transaction log partition. Further, the new data object attributes include a set of new private attributes and attribute values, as well as one or more shared attributes and attribute values.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic representation of the data collection and processing system according to the teachings of the present invention.

FIG. 2 is a more detailed schematic representation of the data collection and processing system of FIG. 1 according to the teachings of the present invention.

FIG. 3 is an example data collection and processing system for collecting, processing and analyzing environmental data according to the teachings of the present invention.

FIG. 4 is a schematic block diagram showing the functional units associated with one embodiment of the post-processing unit of the data collection and processing system of the present invention.

FIG. 5 is a schematic conceptual depiction of a method employed by the present invention for determining the emission of a cluster of an enterprise and for assessing the impact of selected actions taken to remediate the emissions output of the enterprise.

FIG. 6 is a schematic block diagram of another embodiment of the data analysis module of the data collection and processing system 10 of FIGS. 1 and 2.

FIG. 7 is a schematic depiction of the clusters associated with an enterprise and as determined by the partition unit of FIG. 6 according to the teachings of the present invention.

FIG. 8 is a schematic depiction of the clustering and ranking of the emission contributors by the partition unit and the normalization unit of FIG. 6 according to the teachings of the present invention.

FIGS. 9-11 are schematic flow chart diagrams illustrating the method of the present invention.

FIG. 12 is a flowchart illustrating an operation of a blockchain ledger using modular smart contracts according to an embodiment of the present invention.

FIG. 13 is a flowchart illustrating an operation of a blockchain ledger using modular smart contracts according to an embodiment of the present invention.

FIG. 14 is a diagram illustrating a world state database view of a blockchain ledger according to an embodiment of the present invention.

FIG. 15 is a flowchart illustrating an operation of a blockchain ledger using modular smart contracts according to an embodiment of the present invention.

FIG. 16 is a diagram illustrating a world state database view of a blockchain ledger according to an embodiment of the present invention.

FIG. 17 is a schematic block diagram illustrating exemplary hardware that can be employed by portions of the system and by an electronic device employed thereby according to the teachings of the present invention.

### DETAILED DESCRIPTION

The present invention is directed to a data collection and processing system that can be used as an overall financial system (e.g., a tax, accounting, auditing, consulting or advisory system) and associated method therefor for generating and collecting usable, cryptographically verifiable environmental data, enriching the data with data from strategic third party data sources and with environmental data collected with the data collection unit, and then applying if needed advanced risk modelling, machine learning and artificial intelligence techniques, so as to generate strategic reports, such as financial reports and other business-related reports.

The present inventors have realized that there is a need in the art for the ability to determine the carbon footprint of an enterprise or a cluster of an enterprise by determining the emissions of the emission contributors, and by further processing this data, such as with a partition unit and a normalization unit, to determine the total emissions profile of the enterprise, and then determining the impact of climate actions performed or undertaken by the company. That is, the inventors have realized that enterprises, such as businesses and companies, should consider or understand the climate related risks on asset valuations; better assess, understand and respond in appropriate ways to any risks that climate change presents to business operations; employ better systems for accurately assessing, tracking, managing and considering carbon emissions, carbon reductions, and carbon offsets; and secure the data in a trusted, immutable and easily verifiable manner such that the stored and secured data can be easily audited. Further, the present inventors have realized the need to provide a reliable data processing system for processing and enriching the environmental data. In this regard, the system of the present invention can include a data analysis module that includes an enrichment unit having a data layer for storing the environmental data from the plurality of data sources; an applications interface unit having an application unit for storing one or more software applications for processing the environmental data in the data layer; a third party data unit for storing third party data that is related to the environmental data stored in the data; a cognitive intelligence unit for applying one or more pre-defined intelligence techniques to the environmental data so as to process and enrich the environmental data to form enriched environmental data such that the cognitive intelligence unit includes a recommendation engine for applying a machine learning technique, having training data associated with the environmental data, to the environmental data from the data layer to generate predictions based on the environmental data, wherein the predictions are stored in a digital trust infrastructure unit, and a risk model unit for applying one or more risk modelling techniques to the enriched environmental data to assess via probability distribution the likelihood that a selected type of risk event can occur. The risk model unit and the recommendation engine process the enriched environmental data from the application data unit or that is stored in the digital trust infrastructure unit, and the digital trust infrastructure unit employs a blockchain for storing the enriched environmental data to form verifiable and trusted data. The arrangement of the data analysis module 16 to include the enrichment unit 22 having the data layer, application interface unit and cognitive intelligence unit, and the digital trust infrastructure unit so as to process and enrich the environmental data is not contemplated by current systems and is an advance over these systems.

As used herein, the term “environmental data” or “environmental information” is intended to include any type of data associated with the surroundings, conditions or activities of any natural structure, such as the Earth and components thereof, any artificial or man-made structure or enterprise, such as a building, a device, or equipment, or an organization, entity or individual. The data associated therewith can also include any associated identifiable element in the physical, cultural, demographic, economic, political, regulatory, climatic, or technological environment that affects the survival, operations, and/or growth of any of the foregoing. The data can also concern the physical, chemical (e.g., chemicals, fluids, gases and the like), and/or biological factors that can act upon the natural and man-made structures. The physical environment can include the atmosphere, climate, hydrosphere, ocean, and land. The climate related data can include solar radiation data, temperature data, humidity data, emissions data, precipitation data (e.g., type, frequency and amount), atmospheric pressure data, and wind data (e.g., speed and direction). The land related data can include data associated with mountains, plateaus, and valleys, either above sea level or below sea level. The hydrosphere data can include any data related to any water in any form (e.g., liquid, frozen, or vapor) anywhere on Earth. The data can also include power related data that includes for example the consumption of power by different types of building equipment to maintain occupant comfort, air quality, lighting, and the like, as well as power data related to the generation of power from any selected power source and/or feedstock, including for example oil-based power generation, gas-based power generation, coal-based power generation, solar energy, nuclear-based power generation, hydrogen-based power generation, wind energy, or tidal or water generated energy, and any emissions data associated therewith.

As used herein the term “financial data” can include any data that is associated with or contains financial or financial related information. The financial information can include information that is presented free form or in tabular formats and is related to data associated with financial, monetary, or pecuniary interests. Further, as used herein, the term “non-financial data” is intended to include all data, including if appropriate environmental data, that is not financial data as defined herein.

As used herein, the term “enterprise” is intended to include a structure or collection of structures (e.g., buildings), facility, business, company, operation, organization, country, or entity of any size. Further, the term is intended to include an individual or group of individuals, or a device or equipment of any type.

As used herein, the term “financial unit, “financial subsystem,” “financial system” or “financial infrastructure” is intended to include any unit implemented in hardware, software or a combination thereof that applies financial rules and models to data of any type, including financial data and environmental data, so as generate one or more financial reports. The financial rules and modeling can include applying known and/or custom business concepts, accounting concepts, tax concepts, audit concepts, consulting concepts or advisory concepts.

As used herein, the term “financial reports” is intended to include any statement or report that exists in any suitable format (e.g., printed or in digital file format) that sets forth or includes financial data, including, for example, tax returns, income statements, cash flow statements, balance sheets, 10-K statements, 10-Q statements, audit reports, annual reports, loan applications, credit history reports, invoices, and the like.

As used herein, the term “enrich,” “enriched” or “enriching” is intended to include the ability to ingest, integrate, augment, improve and/or enhance data by supplementing missing or incomplete data, correcting inaccurate data, adding additional data, or processing the data using known techniques, such as with artificial intelligence, machine learning and risk modelling techniques, and then applying logic and structure to the data so as to curate the data. The term enrich can also include the ability to correlate factors to the data so as to generate or create meaningful insights and conclusions based on the data, including environmental and financial data.

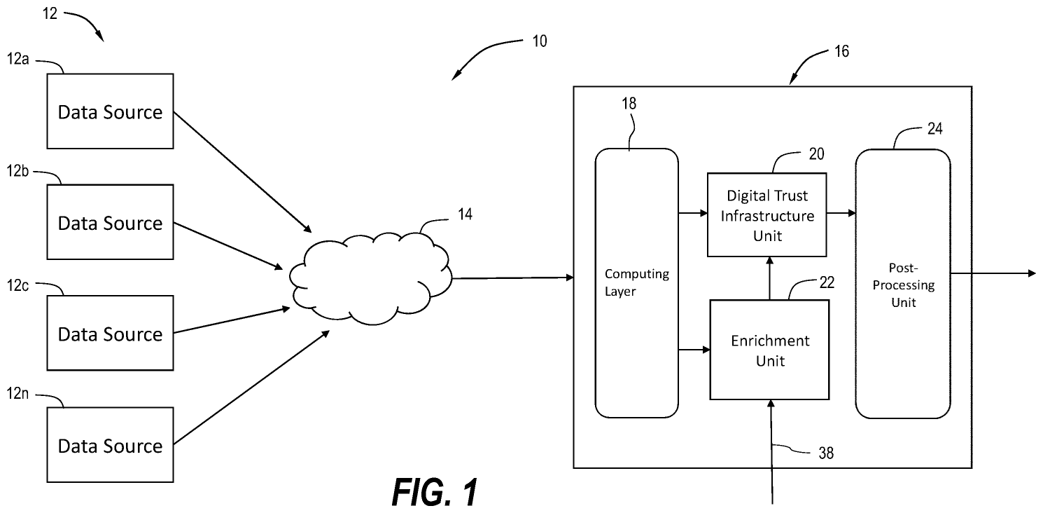

FIG. 1 is directed to a system for integrating, collecting or aggregating data, such as for example environmental data, from a variety of different sources, and then enriching and processing the data for subsequent use in a variety of different ways. As shown, the data collection and processing system 10 can include a plurality of data sources 12, and specifically data sources 12a-12n that are sources of data to be processed by the data collection and processing system 10 of the present invention. According to one example, the data sources 12 can include devices, such as detectors, sensors, and the like that are measuring and transmitting selected data, such as environmental and financial data. The data acquired by the data sources 12a-12n can be conveyed through any suitable data connection via the network 14 to a data analysis subsystem or module 16. The data analysis module 16 stores and analyzes the data received from the data sources 12. The data analysis module 16 can store the data from the various data sources 12, enrich and process the data to generate insights and the like, secure or store the data in a trusted and verifiable manner, and then provide the data to suitable report generating software applications for generating one or more reports, insights, risk modelling, and the like. The data analysis module can also include or employ a financial system or infrastructure for analyzing and processing the data by applying financial rules thereto and for generating enriched financial data, and optionally according to one practice, enriched non-financial data.

The illustrated data analysis module 16 can include an optional computing layer 18 for providing optional computing and storage capabilities closer to the edge of the network. By providing the computing and storage resources closer to the data sources 12 on the network, the computing layer 18 can hence move computation away from data centers and other computing elements towards the edge of the network, thus exploiting for example suitable software applications, smart objects, or network gateways to perform processing tasks and provide services on behalf of the remaining system computing resources. By moving services to the edge, it is possible to provide content caching, service delivery, storage and Internet of Things (IoT) management resulting in better response times and transfer rates. The computing layer 18 thus reduces the volume of data that must be moved, the consequent data traffic over the network, and the overall distance that data must travel. The computing layer 18 can also include if desired relevant applications that can be selected based on the type of data that is transmitted from the data sources 12. Further, the computing layer can employ known virtualization technology for providing enhanced computing services closer to the data sources 12. Alternatively, the computing layer 18 can simply provide processing and storage capabilities, and hence can form part of the data analysis module 16 or can be a separate component. For purposes of simplicity and for ease of explanation, the computing layer 18 is shown as forming a part of the data analysis module 16, although one of ordinary skill in the art will readily recognize that the computing layer 18 can be a separate unit.

The data analysis module 16 can also include a digital trust infrastructure unit 20 for generating trusted and verifiable data via known techniques, such as for example by using blockchain technology. The digital trust infrastructure unit 20 can secure in a trusted and verifiable manner data that is received from one or more components of the data collection and processing system 10, such as for example from the data sources 12, from third party data source providers 38, and from pre-stored data. The data once secured is resistant to change and is easily verifiable. The data secured in the digital trust infrastructure unit 20 can be open for inspection or access to the data and can be restricted in known ways. Also included in the data analysis module 16 is an enrichment unit 22 for enriching the data received from the data sources 12 with, for example, data received from one or more third party sources 38 and/or with the pre-stored data. The enrichment unit 12 can also apply various well known techniques to the data prior to being stored in the digital trust infrastructure unit 20, such as by using machine learning, artificial intelligence and risk modeling techniques to further enrich the data. The enrichment unit 22 serves to ingest and/or enrich the data prior to being stored in the digital trust infrastructure unit 20. The environmental data, the enriched data, the machine learning models and techniques applied to the data, and the insights and conclusions generated by the enrichment unit 22, can also be stored in the blockchain 20A of the digital trust infrastructure unit 20, thus enabling the system to cryptographically verify and store the logic and structure applied to the data so as to curate the data. The stored and verifiable data can also be used for subsequent reporting and analysis.

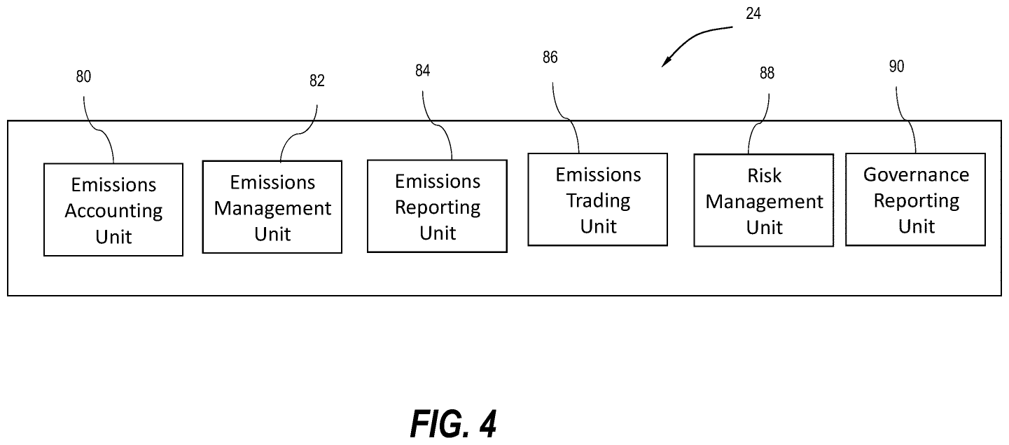

The illustrated data analysis module 16 can also include a post-processing unit 24 for processing the data that is stored within the digital trust infrastructure unit 20. The post-processing unit 24 can include any selected software application, such as suitable report generating applications, for generating reports of any type and kind, including financial reports. The post-processing unit 24 can also include, as shown in FIG. 4, one or more optional units, such as for example an emissions accounting unit 80, an emissions management unit 82, an emissions reporting unit 84, an emissions trading unit 86, and a risk management unit 88.

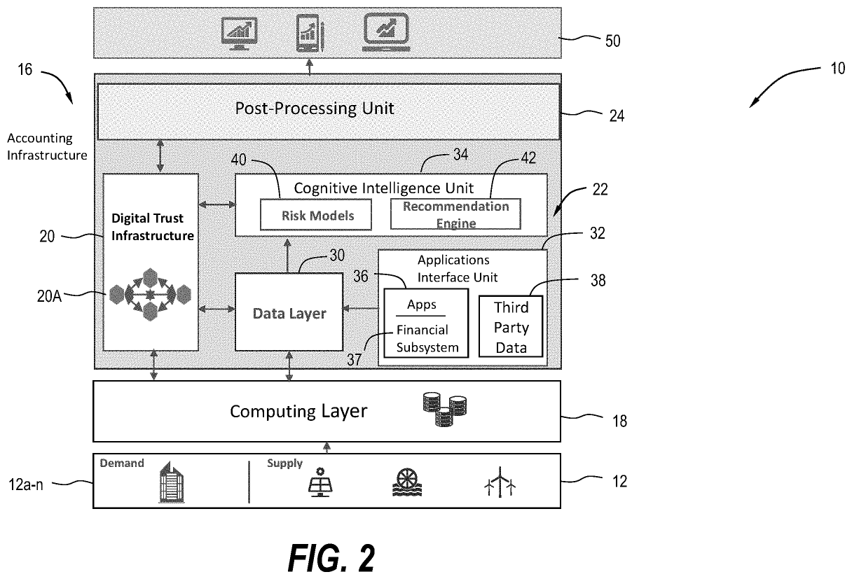

FIG. 2 is a schematic representation of the data collection and processing system 10 showing additional details of the data sources 12a-12n and various units of the data analysis module 16. The data collection and processing system 10 of the present invention includes the data sources 12 that can include any selected type of data, including for example financial data, environmental data, and the like, as well as combinations of different types of data. According to one illustrative example, the data sources 12a-12n can include data that is generated by a plurality of sources or different devices or measuring devices, including for example sensors, detectors, measurement devices and the like. The measuring devices can be coupled to any suitable structure or facility to measure any selected parameter, including for example power generation, power consumption, humidity, occupancy, emissions of various fluids (e.g., liquids and gases) and the like. Further, the data sources 12 can include any selected pre-stored data such as from data libraries relevant to the parameters being detected and/or measured. The data generated or collected by the data sources can include structured as well as unstructured data. The data from the data sources 12 is then conveyed to the optional computing layer 18 or directly to the data analysis module 16. The computing layer 18 can form part of the data analysis module 16 or can be a separate component therefrom. The computing layer can include selected computing hardware, such as processors, memory and storage. The data from the data sources 12 can be stored at the computing layer 18. The computing layer 18 can include relevant software applications and associated protocols for interfacing with the devices, ensuring device connectivity, the ability to process and log the data, store the data, and the like.

The data stored in the computing layer 18 can be conveyed directly to either or both of the digital trust infrastructure unit 20 and the enrichment unit 22. The enrichment unit 22 can include a data layer 30, an application interface unit 32, and a cognitive intelligence unit 34. The data layer 30 is configured to receive the data from the computing layer 18 and then process and store the data therein. The data layer can form a general part of the overall data analysis module 16 or can be deployed as a separate component. The data stored in the data layer 30 can be enriched in various ways. For example, the data can be enriched by one or more of the application interface unit 32 and the cognitive intelligence unit 34. The application interface unit 32 can include and store specific software applications in an application unit 36 that are directed or related to the type of data provided by the data sources. For example, if the data includes environmental data, then environmental data specific applications can be employed, such as for purposes of example the Nantum OS application from Prescriptive Data, USA. The Nantum OS software application unlocks correlated trends and analyzes data from devices such as sensors in disparate building systems (including building management systems (BMS), utility and power quality meters, and access control) and combines this with data from third-party sources 38 to prescribe operational adjustments in real-time that improve building performance and tenant comfort. The application interface unit 32 can also store third party data 38, such as for example, any type of data that is related to the type of data stored in the data layer 30. If the data stored in the data layer is environmental data, then the third party data can include for example weather data, occupancy data, satellite data, GPS data, optical data, physical enterprise data such as data associated with one or more structures, IoT sensors, maintenance related data, equipment related data, spatial related data associated with structures, enterprise data, asset management related data, and the like.

The application interface unit 32 can also include or employ a financial subsystem 37 for storing appropriate financial software applications for applying financial rule sets and logic to the data in the data layer 30 as well as to data that has been enriched by the applications interface unit 32, third party data, and/or by the cognitive intelligence unit 34. According to one example, the financial subsystem 37 can apply accounting concepts or business or advisory concepts to the data.

The cognitive intelligence unit 34 can also be configured to apply risk modelling techniques, artificial intelligence techniques and/or machine learning models or techniques to the data prior to being stored in the digital trust infrastructure unit 20. The various techniques enable real-time adjustments of the data received from the data layer based on various factors, including data type and how the data is used by the enterprise. For example, the environmental data can be employed to make adjustments to one or more parameters of an enterprise, such as by adjusting the temperature, speed, lighting, and the like. The system can alternatively be used to assess, monitor or predict the carbon foot-print (usage and emissions) of an enterprise on any time scale. For example, the recommendation engine 42 can employ one or more machine learning techniques that can include a variety of algorithms (e.g., supervised learning, unsupervised learning, reinforcement learning, knowledge-based learning, natural-language-based learning such as natural language generation and natural language processing, deep learning, and the like) and can access execution engines comprising software applications that enable implementation of the underlying algorithm. As is known, the machine learning techniques are trained using training data. This training data is used to modify and fine-tune the weights associated with the machine learning models, as well as record ground truth for where correct answers can be found within the data. As such, the better the training data, the more accurate and effective the machine learning model can be. The recommendation library or engine 42 processes the data in the data layer by applying one or more machine learning or artificial intelligence techniques so as to generate or extract recommendations, insights, predictions and the like from the data. The cognitive intelligence unit 34 can also employ a risk model unit 40 that includes suitable software for applying one or more risk modelling techniques to the data that model or address strategic, operational, compliance, geopolitical, and other types of risk. The wider availability of data and sophisticated analysis capabilities of the risk models makes modeling more practical. As is known, a risk model is a mathematical representation of a system that commonly includes probability distributions. The models use relevant historical data as well as relevant third party data to understand the probability of a risk event occurring and its potential severity from the input data. Thus, the risk models can be employed to assess many different types of risks. In the current system 10, the risk model unit 40 can process the data in the data layer 30 that is received from the data sources, such as device level data, so as to project, predict or calculate selected risks to an enterprise based on the data.

The data from the computing layer 18 and/or the enriched data from the enrichment unit 22 can be stored in the digital trust infrastructure unit 20. For example, the data (e.g., original or raw data) from the computing layer 18 can be stored directly in the digital trust infrastructure unit 20. Alternatively, the original data can be conveyed to the data layer 30, and the original data can be enriched to form enriched data by one or more of the data received from the third party sources 38, by the software applications 36, by the software in the financial subsystem 37, by the risk modelling software stored in the risk model unit 40, or by the machine learning or artificial intelligence techniques implemented by the recommendation engine 42. As such, the data collection and processing system 10 can be configured to store in addition to the original data the enriched data as well as the techniques or third party data that was employed to enrich the original data in the blockchain 20A. The digital trust infrastructure unit 20 preferably stores the original data and the enriched data in a trusted and verifiable format. According to one practice, the data can be stored using blockchain technology. In a blockchain 20A, as is known, the original data or the enriched data can be stored in a series of batches or blocks that include among other things a time stamp, a hash value of the data stored in the block, a copy of the hash value from the previous block, as well as other types of information, including for example the origins of the data. The blockchain 20A is shared with a plurality of nodes in a blockchain network in a decentralized manner with no intermediaries. Since many copies of the blockchain exist across the blockchain network, the veracity of the data in the blocks can be easily tracked and verified. Each instance of new data from the data sources 12 or data and models and techniques employed by the enrichment unit 22 can be stored in a block on the blockchain. The blockchain 20A thus functions as a decentralized or distributed ledger having data associated with each block that can be subsequently reviewed and/or processed. The data in the blockchain can be tracked, traced, and presented chronologically in a cryptographically-verified ledger format of the blockchain to each participant of the blockchain. As such, the blockchain can provide an audit trail corresponding to all of the data in the blocks, and thus can determine who interacted with the data and when, as well as the sources of the data and any actions taken in response to the data. According to one embodiment, each node of the blockchain network can include one or more computer servers which provides processing capability and memory storage. Any changes made by any of the nodes to a corresponding block in the blockchain are automatically reflected in every other ledger in the blockchain. As such, with the distributed ledger format in the blockchain, provenance can be provided with the dissemination of identical copies of the ledger, which has cryptographic proof of its validity, to each of the nodes in the network. Consequently, all of the various types of data (e.g., original data, enriched data, the software and models and techniques employed to enrich the data, and the insights and recommendations generated therefrom) can be stored in the blockchain 20A, and the blockchain 20A can be used to verify, prove and create an immutable record of the data, various rule based models and techniques, risk models, and machine learning and artificial intelligence models and techniques stored therein as well as to track users accessing the data and any associated insights generated by the enrichment unit. The combination of the enrichment unit 22 and the digital trust infrastructure unit 20 forming a data analysis module 16 provides for a subsystem for enriching and storing data in a blockchain, such as original and enriched environmental data, as well as the associated techniques and data types used to enrich the data, in a trusted storage medium. The data analysis module 16 of the present invention provides for a significant advance over prior art systems that are not constructed to gather, integrate, collate, enrich and then store in a blockchain original and enriched environmental data.

The data stored in the blockchain 20A of the digital trust infrastructure unit 20 can be viewed, retrieved and processed using the post-processing unit 24. For example, the post-processing unit 24 can include one or more software applications that processes and integrates the data stored in the digital trust infrastructure unit 20 so as to generate one or more reports that are configured to provide information to a system user that is related to the data. For example, the post-processing unit 24 can employ data visualization software that analyzes the data and then displays the data in selected visualization formats, such as graph-type visualization formats. The post-processing unit 24 can also be configured to create standardized and configurable reports for clients specific to their jurisdictional compliance requirements, as well as provide business insights and associated analytics from the data. The reports can also be industry specific, domain specific, or can generate or create reports that relate to risk monitoring and controls. The reports can include financial reports and the like. According to one practice, the reports can include, when processing environmental data, an emission history report, water usage report and other enterprise (e.g., building) specific reports, as well as provide a summary dashboard showing selected metrics or parameters, including building efficiency and the like. An example of suitable data visualization software includes the various software applications products from Tableau Software, USA. An example of a suitable data integration and business analytics software includes the various software applications from Qlik. The reports generated by the post-processing unit 24 can be displayed in a display region 50. The display region can include one or more displays or monitors for displaying the reports. The displays can be separate display devices or can form part of any suitable electronic device, such as for example a computer, tablet or smartphone.

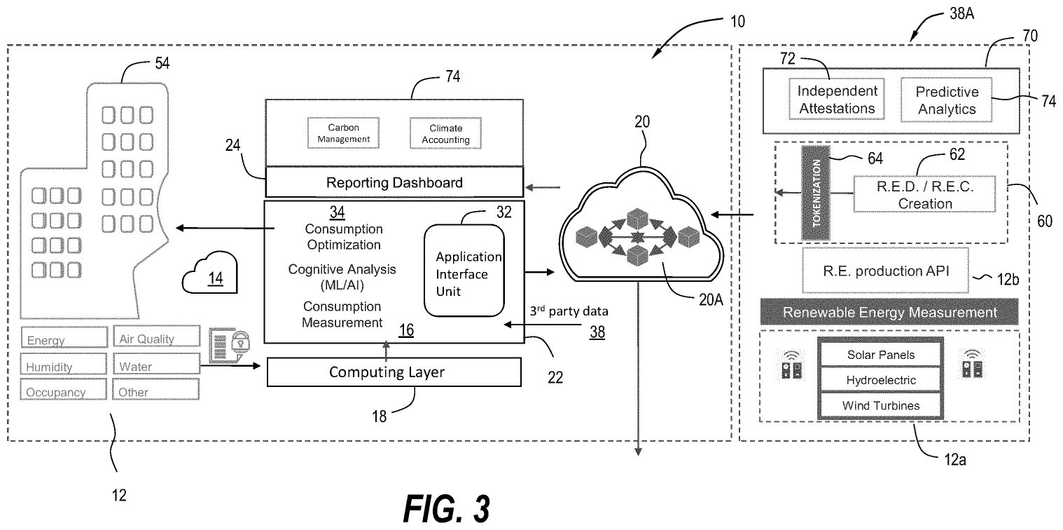

The data collection and processing system 10 of the present invention can be employed to create an environmental and financial infrastructure for allowing financial institutions to process environmental and/or financial data so as to provide financial, tax, accounting, consulting, and business related services (including risk modelling services) to clients. By way of example, and for purposes of simplicity, FIG. 3 shows an example of the data collection and processing system 10 configured for processing environmental data according to an exemplary technique. Those of ordinary skill in the art will readily recognize that the system 10 can be employed to gather, process, enrich and analyze many different types of data. The data can be provided by data sources 12 that provide environmental data associated with a structure, such as a building 54. In the illustrated embodiment, the data sources 12 can provide original or raw environmental data associated with various building associated parameters, such as for example, energy consumption, humidity, occupancy, air quality, water usage, and the like. The original environmental data can be communicated via the network 14 to the computing layer 18 and then to the data analysis module 16. Specifically, the original environmental data can be collected in the computing layer 18 and can be indicative of asset grade environmental data. An example of a software application that can be employed to ingest or collect the environmental data in the computing layer 18 is any of the suitable software applications from Context Labs. The original environmental data stored in the computing layer 18 is then transferred or conveyed to the enrichment unit 22 of the data analysis module 16. The enrichment layer 22 can include for example the application interface unit 32 and the cognitive intelligence unit 34. In the application interface unit 32, suitable software, such as Nantum OS from Prescriptive Data, can store and analyze the environmental data received from the data sources 12 associated with the building 54. The enrichment layer 22 can recommend adjustments to be made to the building operational systems so as to improve overall building efficiency and tenant comfort. The application interface unit 32 can also include the financial subsystem 37, FIG. 2, for applying financial concepts and logic to the environmental data (and to financial data) and for generating or extracting financial data therefrom. Further, environmental data from the third party sources 38 can also be provided to further enrich the original environmental data and optionally the financial data. The third party data 38 can include for example environmental data associated with the operations of the building 54 or similar or different types of buildings, specifications of equipment employed in the building 54, external environmental data such as geospatial, weather, temperature, humidity, wind, sun exposure and the like, spatial information regarding the building layout, power grid information, and maintenance information regarding one or more aspects of the physical plant. This list of third party data is merely exemplary and is not intended to be exhaustive. The third party data 38 is intended to improve the quality and integrity of the environmental data. The cognitive intelligence unit 34 can include techniques or models for synthesizing, improving, enriching or optimizing the original or enriched environmental data, including data associated with overall consumption and measuring of the overall consumption, and then subsequently analyzing the data using risk modelling, machine learning and/or artificial intelligence techniques. The cognitive intelligence unit 34 can process the data by applying thereto techniques that can be employed to derive insights relative to the environmental data for decision making, performance, optimization and risk management. The processed and analyzed (e.g., enriched) data in the enrichment unit 22 can then be conveyed back to the emission contributor (e.g., building 54) to adjust or control one or more environmental or operational parameters of the emission contributor and/or can be conveyed to the digital trust infrastructure unit 20 for storage in a blockchain 20A. When conveyed back to the building 54, the various systems in the building can be modified so as to operate the physical facility in a more cost and environmentally friendly and efficient manner. Further, the system can be employed to determine a portion of or the entire carbon chain or footprint of the enterprise from source to recycle or reuse. The entire carbon chain or footprint includes a number of activities, including for example tracking, monitoring and assessing the carbon usage or generation associated with, for example, the raw materials that are sourced for making a device or a building or equipment, the activities associated with transporting the raw materials to a processing or production location, the processing of the raw materials, the activities associated with assembling or manufacturing the designed product, the activities associated with the storing, distributing, and selling the product to customers including the enterprise, and customers using the product. The carbon chain also includes activities associated with the enterprise (e.g., customer), such as operating their facilities, the reuse or recycling of emissions or materials, and the like. The climate related data (e.g., emissions data) can used to determine the appropriate climate actions, the impact of selected climate actions on the enterprise, and to help determine the allocation of resources, including financial resources.

The digital trust infrastructure unit 20 can utilize any known technique for storing and securing the original environmental data, the enriched environmental data, the financial and non-financial data, whether enriched or otherwise, as well as the specific risk models and machine learning and artificial intelligence techniques that were employed by the enrichment unit 22 to enrich the environmental data. According to one practice, the environmental data can be secured or stored using blockchain technology. The digital trust infrastructure unit 20 can thus employ a blockchain 20A to store the foregoing types of data, including enriched data, in a decentralized, trusted and cryptographically verifiable manner. The data can be stored therein according to known techniques. The data can include the original or raw device level environmental data as well as the enriched environmental data that is secured and verified, and hence is trusted. The blockchain 20A can also store data directly from additional third party sources 38A. The third party sources 38A can include supply data, such as for example power supply data including environmental data 12a associated with selected types of renewable energy, such as solar, wind, or hydroelectric, that are being generated or produced at selected power installations. The third party data 38A can also include environmental data 12b generated by third party applications associated with or directed to renewable energy production, such as data collated and processed by software applications by SwytchX.

The illustrated third party sources 38A can also include an optional token creation unit 60 for receiving or collecting data associated with renewable energy production and emissions from selected installations and creating tokens related to this data. The tokens can represent any physical or digital pre-defined or selected amount or quantum of value. The tokens can be purchased, sold, exchanged, traded or redeemed per the system requirements. The system can also track the tokens if desired. The renewable energy production and renewable energy emissions can be converted into renewable energy credits and renewable energy debits by a conversion unit 62. The renewable energy credits and debits can be converted into tokens by a tokenization unit 64. The tokens created by the tokenization unit can be conveyed to the digital trust infrastructure unit 20 for storing in the blockchain 20A. The third party data sources 38A can also include an optional financial verification unit 70 for verifying data, tokens or related information associated with the third party sources 38A. The verification unit 70 can include an optional attestation unit 72 for providing attestation data associated with selected environmental data or tokens and which can be provided by any selected financial institution or attestation body, such as for example an accountant, accounting firm, attorney, law firm, business, and the like. The attestation data is a documented verification of the validity of the underlying data. The verification unit 70 can also include an optional predictive analytics unit 74 for analyzing selected data and for providing predictions based on the data. All of the information received from the third party source 38A can be transferred to the digital trust infrastructure unit 20 for storing therein.

The data stored in the blocks of the blockchain 20A can be retrieved and processed by the post-processing unit 24 to generate one or more reports, such as environmental or financial reports, or other types of reports, via one or more suitable report generation applications. The environmental data can be employed to identify and analyze the emission contributors of one or more clusters of an enterprise and how best to reduce the emissions thereof. From this environmental data (e.g., emissions data), the data analysis module 16 can determine the operational health of the building and associated systems, and perform a risk analysis on the physical building and associated external and internal climate. The reports can include among other things reports on green house gas emissions, green house gas optimization, carbon emission setting and optimization, risks and associated controls, transaction settlements, net-zero emissions compliance, and carbon pricing. The post-processing unit 24 can also optionally create if desired a reporting dashboard. The reports and the dashboard can be displayed in the display region 50, FIG. 2. The enrichment unit 22 can also include an optional financial analysis unit 74, similar to the financial subsystem 37, that can reside for example as part of the cognitive intelligence unit 34 or as a separate component or unit. The financial analysis unit 74 can analyze the data received from the digital trust infrastructure unit 20 to identify, process and analyze certain financial aspects of the environmental data. For example, the data can be processed using standard financial or accounting rules, logic and models and techniques. Also the financial analysis unit 74 can determine the carbon footprint associated with the environmental data. The financial analysis unit 74 can be used in place of the financial subsystem 37 or can be used in conjunction with the financial subsystem 37.

The post-processing unit 24 can also be configured to generate reports, which can include selected environmental data that is important to a selected client relative to one or more enterprises or buildings, and then display the reports to the system user. The reports can be constructed so as to allow the user to view and analyze the data, such as environmental data, so as to help make decisions or to take or recommend actions in response thereto and which are related to selected system capabilities or functionalities, including for example emissions accounting, emissions management, emissions reporting, emissions trading, and risk management. The data collection and processing system 10 of the present invention can employ selected software modules or units in the post-processing unit 24 directed to one or more of the foregoing capabilities. The selected software modules can be configured to process data from one or more selected types of data sources 12, thus allowing the client to access granular environmental data, such as for example emissions related data, so as to derive insights across the users operations in near real time.

FIG. 4 is a schematic block diagram showing the post-processing unit 24 configured to optionally include or employ one or more selected units for generating one or more reports directed to a selected system capability or functionality of the enterprise. For example, regarding the emission accounting capability, the post-processing unit 24 can be configured to include an optional emissions accounting unit 80 that can include one or more software applications and associated hardware for processing the enriched environmental data to aggregate data related to the energy consumed or used by the enterprise, such as a structure or collection of structures (e.g., buildings), equipment, facility, business, company, operation, organization, country or entity, to compute various emissions-related metrics using standard emissions factors available from third-party sources, for example, the emissions factors provided by the International Energy Agency (IEA); to track emissions relative to established emissions goals for a specific building, equipment, enterprise, or country; and to determine the overall emissions related liabilities of the enterprise. Specifically, the emissions accounting unit 80 can determine or calculate the emissions of an enterprise or building, determine and track energy consumption of the enterprise, and/or determine or track the overall emissions goals for the enterprise based on the environmental data and/or third party data following applicable climate-related accounting standards and frameworks. The climate related standards can include for example standards and frameworks established by greenhouse gas protocols, sustainability accounting standards boards (SASB), task forces on climate-related financial disclosures (TCFD), global logistics emissions council (GLEC), and global reporting institute (GM). The emissions accounting unit 80 can also be configured to track emissions generated from their operations with the required level of granularity or specificity for deciding specific to reducing emissions through various known carbon management strategies. For example, the emissions accounting unit 80 can use the environmental data to determine the biggest emission generators in the building and then take selected emissions remediation actions (e.g., climate actions), such as for example upgrade the emission sources, initiate repair or maintenance of selected building components, and to forecast future investment needs. The climate actions can also include for example initiatives related to carbon reduction (e.g., energy efficiency), carbon removal, carbon offsetting, carbon capture and storage, and the like.

The post-processing unit 24 can also include an optional emissions management unit 82 that can include one or more software applications and associated hardware for processing the enriched environmental data to manage the emissions of the enterprise. Specifically, the emissions management unit 82 can determine or calculate the emissions reduction achieved by the enterprise when utilizing different energy optimization measures, projects or programs via suitable software applications, the replacement of equipment, retrofitting equipment with advanced sensor and control capabilities, or automating command and control of the building control systems and associated IoT devices. The emissions management unit 82 can also determine the overall energy consumption of the enterprise and allow the integration of this enriched environmental data with third party data sources to facilitate the procurement of energy for the enterprise. For example, the enterprise can leverage the enriched environmental data generated by the enrichment unit 22 by applying artificial intelligence or machine learning or other advanced analytics techniques to determine the right mixture of energy to use, in the right amounts, at optimal prices from energy suppliers. The emissions management unit 82 can also include suitable software for tracking carbon prices as set forth by regulatory bodies specific to a jurisdiction or by the enterprise, and facilitate the determination of carbon-related liabilities applicable to the products or services or both of the enterprise. In addition, the emissions management unit 82 can use the enriched environmental data for collecting the carbon-related liabilities from enterprises or business units or other sources, acquiring the environmental funds provided by various sources identified by the enterprise and others, and tracking the allocation of the funds for investing in various climate actions of the enterprise. This can also include determining the insights related to managing the emissions fund with necessary audit, tax and risk management models.

The post-processing unit 24 can further include an optional emissions reporting unit 84 that can include one or more software applications for processing the enriched environmental data to generate a report directed to the emissions profile of the enterprise in compliance with jurisdiction specific regulations. Specifically, the emissions reporting unit 84 can generate one or more reports that includes climate data and generate one or more reports directed to certifying the accuracy of the inventory of greenhouse gas emitters, certifying the source of the environmental data with necessary third party verification data, and the methodology and/or technique used to calculate emissions. The emissions reporting unit 84 can also employ suitable computation engines to automatically generate relevant disclosure statements to be included in the report. The emissions reporting unit 84 can further be configured to automatically generate standardized or custom climate disclosure reports in compliance with jurisdictional laws, such as local, state, and federal laws, and specific regulatory guidelines. The reporting unit can also be configured to certify the reports use by shareholders of the enterprise as part of associated financial disclosures and annual reports, thus allowing the shareholders the ability to assess and track the climate progress of the enterprise. The emissions reporting unit 84 can employ pre-defined techniques to track and analyze the impact of the different climate actions undertaken by the enterprise to reduce their overall emissions and leverage the insights generated by the cognitive intelligence unit 34 for subsequent emissions planning.

The post-processing unit 24 can still further include an optional emissions trading unit 86 that can include one or more software applications for processing the enriched environmental data to provide information or reports related to the trading of emission related credits between enterprises. More specifically, the emissions trading unit 86 can determine or calculate a carbon allowance (e.g., cap or target) associated with the enterprise and to track or record any carbon credits purchased by the enterprise from third party sellers; to generate one or more digital tokens representative of the excess carbon available as credits; to manage the trading of carbon credits or tokens in a related marketplace; and/or to track the aggregated (“earned”) carbon credits available with the enterprise or used by the enterprise in compliance with regulatory and jurisdictional guidelines at the required granularity specific to the enterprise.

The post-processing unit 24 can also include an optional risk management unit 88 that can include one or more software applications and associated hardware for processing the enriched environmental data to model or determine and hence manage any financial and non-financial risks to the enterprise based on the environmental data. More specifically, the risk management unit 88 can determine the financial risk via a financial risk value or score associated with the enterprise based on the enriched environmental data or environmental data, evaluate the impact of various climate scenarios or events (e.g., heat waves, cyclones, hurricanes, earth quakes, rise in sea level, disease outbreaks, landslides, and the like) on the sustainable financial performance of the enterprise, evaluate supply chain and operations of the enterprise, and determine any existing and potential vulnerabilities in the systems available within the enterprise, based on the environmental data, and/or to determine whether the enterprise complies with selected regulations and to mitigate any deficiencies related thereto. The risk management unit 88 can also generate insights that can help the enterprise value any associated assets, such as buildings, facilities, infrastructures, and the like, and determine the underlying risks when underwriting financial instruments, such as getting loans at the right interest rate, deciding on investment strategy, reconfiguring the fund allocation actions, managing the brand equity or defining or employing risk mitigation strategies to lower the impact of climate events or scenarios on the financial performance of the enterprise.

The risk management unit 88 can also generate insights from enriched environmental data collected from the assets, such as buildings, facilities, infrastructures, renewable energy generation solutions or systems including solar, wind, fuel cells, biofuels, and the likes, and energy storage systems including battery storage, gravity storage and the likes, to determine the financial and emissions impact of the investments made in such assets to achieve the carbon emissions reduction targets established voluntarily by the enterprise or mandated by regulations or an industry consortium or the likes. The risk management unit 88 can also generate insights from enriched environmental data to identify the key factors impacting the performance of an investment in the assets described above and benchmark or compare the emissions reduction-related commitments at different stages, such as project design, project qualification for investing, project execution, post-project execution, steady-state operations, selling, buying, leasing, and the likes, of financing the projects.

The post-processing unit 24 can further include an optional governance reporting unit 90 that can include one or more software applications for processing the enriched environmental data to generate a report directed to the social and governance profile of the enterprise in compliance with jurisdiction specific regulations. As used herein, the term “governance profile” is intended to mean any information associated with or directed or related to the social, corporate, employee, investment, social, or environmental aspects or governance of the enterprise. Specifically, the governance reporting unit 90 can generate one or more reports that includes environmental data, employee profile, investments made by the enterprise in community development, and the like, and the reporting unit 90 generate one or more reports directed to certifying the accuracy of the social and governance claims of the enterprise, certifying the source of the environmental data with necessary third party verification or notary or certification, and the methodology and/or technique used to assess performance of the enterprise against metrics established by regulators, standards bodies or enterprise policies. The governance reporting unit 90 can also employ suitable computation engines to automatically generate relevant disclosure statements to be included in the report. The governance reporting unit 90 can further be configured to automatically generate standardized or custom social and organizational governance-related disclosure reports in compliance with jurisdictional laws, such as local, state, and federal laws, and specific regulatory guidelines. The reporting unit 90 can also be configured to certify the reports use by shareholders of the enterprise as part of associated financial disclosures and annual reports, thus allowing the shareholders the ability to assess and track the progress of the enterprise towards established social and governance targets. The governance reporting unit 90 can employ pre-defined techniques to track and analyze the impact of the different climate actions undertaken by the enterprise to reduce their overall impact and performance leveraging the insights generated by the cognitive intelligence unit 34 for subsequent social and governance actions planning.

The data collection and processing system 10 of the present invention can measure, collect and calculate the different greenhouse gas (GHG) emissions from the operation related energy consumption of the enterprise for climate accounting purposes. The data collection and processing system 10 can also be configured to manage the emissions of the building as well as the related auditing functions, including monitoring, audit and control of the environmental parameters of the building. The system 10 can also be configured to optimize the environmental performance of the building and reduce the operational costs of the building, while concomitantly reporting the climate impact of the building in an accurate and transparent manner.

The data collection and processing system 10 of the present invention can also be employed by many different types of enterprises across many different types of business sectors that have a need or desire to employ environmental data, as well as other types of data, to reduce the overall carbon footprint of the business operations, lower operational costs, and mitigate climate-related physical and transitional risks that impact the financial performance of the business. Further, the system 10 of the present invention enables businesses to integrate environmental data to assess the quality of assets, such as property assets, measure the overall climate exposure of the asset, and advise businesses on the financial risks associated with the asset.

The data collection and processing system 10 of the present invention integrates different technologies in a cloud based manner to collect environmental data from various data sources 12 and thus form the backbone of an environmental accounting infrastructure. The system 10 can process, enrich, store, audit and authenticate the environmental data in a highly automated manner. The cognitive intelligence unit 34 of the data analysis module 16 can derive granular insights and help enterprises make predictions for how best to optimize resources or manage portions of or the entire emissions or carbon footprint of the enterprise, so as to help mitigate the overall environmental impact of the enterprise. The reporting functions of the post-processing unit 24 and the financial verification unit 70 can allow the attestation body (e.g., accounting firm) to attest and certify environmental related disclosures for financial and non-financial reporting and compliance within the context of standard accounting frameworks.

Further, the environmental financial system implemented by the data collection and processing system 10 allows enterprises to measure, manage, and reduce carbon emissions and help trace the energy supply and demand pipeline. The environmental data accumulated by the system 10 can be integrated with a high degree of confidence and trust into the financial analysis. The system can also help selected attestation bodies track and account for carbon emissions and carbon removal (e.g., credits and debits) transparently and accurately. The attestation bodies can harness the accounting infrastructure of the system 10 to help clients understand the impact of climate risks on asset valuations, business operations, and financial performance.

The data collection and processing system 10 of the present invention can also be used by the enterprise to align together, and to consider in coordination with other factors, the climate strategy and goals of the enterprise, the impact on the enterprise of climate risks, such as those associated with manufacturing and infrastructure, and the overall investment strategy of the enterprise, including the use or employment of renewable assets and the like. These factors enable the enterprise to determine the proper areas for investment, whether through carbon offsets or credits, the utilization of renewable resources, the retrofitting of equipment, and the like.

The data collection and processing system 10 also enables the enterprise to create an auditable record of the environmental data, financial data, and non-financial data and associated metrics that are required to allow the enterprise to determine accurately an overall emissions strategy and carbon footprint of the enterprise. This information can be employed to help determine the proper climate actions to deploy, the effectiveness of the climate actions, as well as how best to invest resources of the enterprise. The system 10 can also allow the enterprise to account for the emissions and climate actions enterprises can implement so as to conform with regulatory requirements and associated standards, while concomitantly measuring the overall effectiveness of the resources enterprises allocate to achieve the climate goals. The system 10 can also allow the enterprise to analyze actions taken in response to the environmental and financial data so as to estimate the specific emissions of individual decarbonization initiatives, and the post-processing unit 24 of the system can be employed to provide reports that benchmark performance against selected financial information, such as investment portfolios and the like, in order to assess risks and portfolio level impacts. The post-processing unit 24 can also be employed to provide data to inform various internal and external stakeholders, such as regulators, investors, lenders, underwriters, customers, and consumers, on the emissions footprint of the enterprise and the progress towards net-zero goals. For example, the post-processing unit 24 can employ the emissions accounting unit 80, the emissions management unit 82, and the emissions reporting unit 84. The system 10 so employed allows the enterprise to develop a framework for auditing, verification, assurance, and attestation of the information and data reported by the enterprise against their climate disclosures and general climate and financial commitments.

A drawback of conventional systems for assessing climate risk is that they tend to segregate or silo data such that all data across the enterprise that is relevant to a selected climate initiative may not be considered or analyzed by the system. To the degree that data may be shared, the data quality tends to be of relatively poor quality and the integrity of the overall data is suspect since it is not stored in an immutable manner. The present invention addresses these issues by providing a data collection and processing system 10 that curates data, such as environmental data, financial data, and non-financial data, thus providing a high degree of data integrity while concomitantly allowing the system to easily determine data provenance, fidelity, and veracity.

The present invention also allows the enterprise to measure, trace, and store climate related data across the enterprise. The climate related data can include for example emissions data associated directly and indirectly with the enterprise. The direct emissions data can include data associated with the generation of emissions from carbon-based sources, such as power generating equipment, locomotive equipment, and the like. The indirect emission data can include data associated with the emissions associated with the purchase or utilization of resources, such as fuel, the generation of energy, emissions associated with activities occurring in the value chain, and the like. The data collection and processing system 10 can also analyze, trace, and store information associated with emissions that are avoided with the use, purchase or deployment of a product or service by the enterprise to help mitigate or reduce emissions. For example, the emission or carbon footprint can be reduced by employing more energy efficient parts and systems.

The illustrated data collection and processing system 10 can help determine the scope of business activities of the enterprise to include an inventory of some or all green-house gas (GHG) emission contributors, and then apply a methodology to identify, acquire and estimate emissions for measuring progress towards selected climate goals of the enterprise. The emissions data can form part of the environmental data described and processed herein. The data collection and processing system 10 of the present invention for example can employ data received from sensors, detectors, and other data sources related to emissions emitters of the enterprise, as well as employ other types of environmental data, including for example water usage, real estate or land use, waste generation and the like. The information can be collected from the various data sources via suitable measuring devices, such as meters, as well as from non-device third parties. The system 10 can also evaluate the impact of the different decarbonization paths that enterprises can adopt or pursue to account for emissions reduction while assessing the effectiveness of the paths to achieve the climate goals of the enterprise. The emissions reduction can be as a result of retrofitting one or more system components to more energy efficient devices, employing heat recovery techniques, employing renewable energy sources in place of higher emission energy sources, and the like.

The system 10 can also employ or take advantage of any emissions or carbon offsets that may be available to the enterprise. For example, the token creation unit 60 can generate one or more carbon tokens associated with the enterprise if available. The information associated with the offsets, as well from the emissions measurement and reduction activities, can be stored in the block chain 20A. The data collection and processing system 10 can thus maintain a provable record of the various actions the enterprise can take to acquire offsets, as well as any attributes available to establish credibility, thus avoiding double accounting of the purchased offsets.

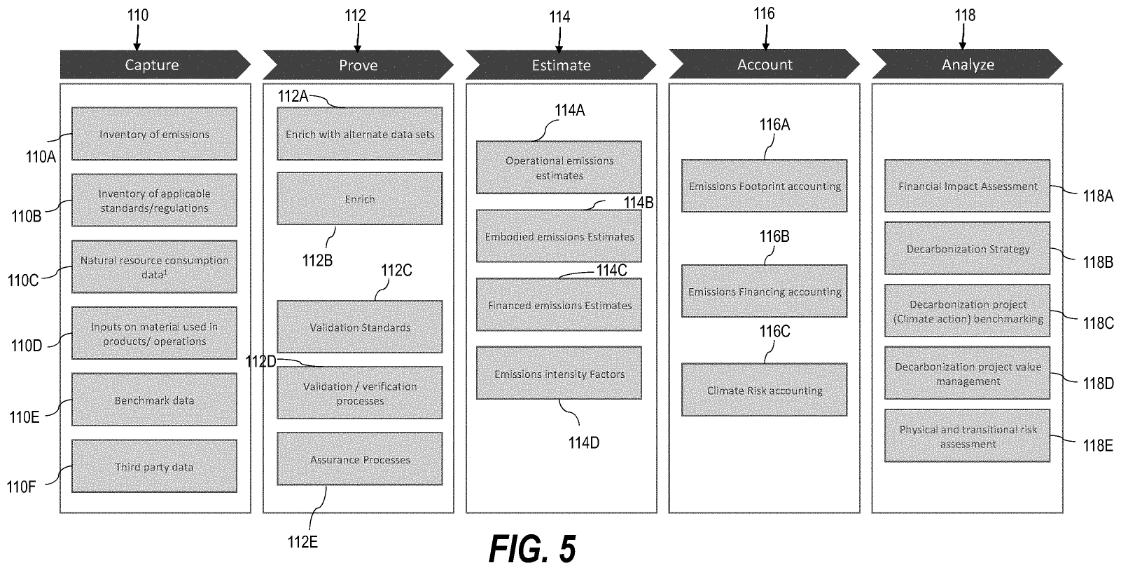

The methodology associated with capturing the emissions data according to the teachings of the present invention is conceptually shown in FIG. 5. The environmental data, such as emissions data, can be captured during the capture step 110. During the capture step, the system 10 can take an inventory of emissions associated with the enterprise or a portion of the enterprise (e.g., cluster) and as measured by associated devices, step 110A. The system can also access a normalization unit 100 for information associated with applicable standards and regulations, step 110B. The data sources 12 can also be associated with devices for measuring the consumption of natural resources by the enterprise, step 110C. The enterprise may also be associated with the production of a product, for example, and as such the system 10 can retrieve emissions related data associated with the materials used in the production process, step 110D. If required, the system 10 can account for benchmark data, step 110E. For example, an enterprise can analyze its historical environmental and non-environmental data using machine learning or other advanced analytical techniques or purchase industry benchmark data provided by third parties to create comparative metrics and targets. As noted, the system 10 can also receive data 38 from third parties, which can include weather data, satellite data, GPS data and the like, step 110F.

The illustrated method can also include a prove step 112 for processing, enriching and validating or verifying the emissions data. For example, in the prove step 112, the enrichment unit 22 can enrich the emissions data from the data sources 12, step 112B, and can further employ alternate data sets to enrich the data, step 112A, in ways to verify the fidelity and increase the veracity of the data in a sufficient manner so as to use the data reliably in making financial and non-financial decisions. The prove step 112 can also employ a validation procedure by applying one or more relevant industry, environmental or emissions related standards, step 112C, as well as processes for verifying the data, step 112D. The validation procedure can also be configured to use data associated with the relevant emissions related compliance obligations or recommendations established by regulators or accounting standards boards or voluntary task forces established by participants in market activities. The method employed by the data collection and processing system 10 can also include a process for assuring the data, step 112E, by analyzing or comparing the data to established accounting and estimation standards and principles as a way to improve the confidence score of or confidence in the environmental or emissions data, as well as confidence in any information derived from the data for decision makers.

The illustrated method can also include an estimate step 114 for estimating the emissions associated with the enterprise. For example, the emissions resulting from the construction of a structure or a facility or a building or equipment or the like, known as embodied emissions, can be captured, verified, and then estimated using the source data, step 114A. Specifically, the emissions associated with or embodied in a structure or a facility or a building or equipment or the like, can be estimated by the system 10, step 114B. The method of the present invention can also estimate the financed emissions originating from investments or funding provided by a financial or a non-financial institution of economic activity of a company or an enterprise, step 114C. The system can also apply or employ a set of emissions intensity factors established or recognized by selected agencies, such as for example by the International Energy Agency (IEA), for estimating emissions of the different natural resources, such as coal, natural gas, methane, nitro oxide, chlorofluorocarbons, and the like, consumed by or associated with the enterprise, step 114D. As used herein, the term “emission intensity factor(s)” is intended to mean the emission rate of a given pollutant relative to an intensity of a specific activity or an industrial or commercial production process. The emission intensity factor can be defined in any selected manner, such as by simple way of example, as a ratio of greenhouse gas emissions produced relative to gross domestic product (GDP). The emission intensity factor can be used to derive estimates of emissions based on an amount of fuel combusted, the number of animals in animal husbandry, on industrial production levels, distances traveled or similar activity data. The emission intensity factor can also be used to compare the environmental impact of different fuels or activities performed by the enterprise.

The method of the present invention can also account for or determine the emissions associated with the enterprise, step 116. For example, the system can process the emissions data to determine the overall emissions footprint of the enterprise, step 116A. The method also contemplates accounting for the financing activities conducted by the enterprise to raise capital for funding different projects that can be, for example, focused on reducing the overall carbon footprint of the enterprise, track the impact of investments on the company's balance sheets, the economic outcomes, and the like, step 116B. Further, the system 10 via the risk management unit 88 can determine the overall impact of climate-related risks on the balance sheet by accounting for any mitigation and abatement actions taken to lower exposure to climate-related risks as required by regulations or legal mandates established by investors, lenders, underwriters and the like, step 116C.

The method also includes analyzing the results of the processing of the emissions data, step 118. For example, the method includes performing an assessment of the financial impact of the emissions footprint on the enterprise, step 118A. The method also contemplates processing the emissions data and then determining a decarbonization strategy based on the total emissions of the enterprise, identification of the source of the emissions, and the like, step 118B. The decarbonization strategy can be compared with a suitable benchmark in order to assess progress towards emissions reduction goals, step 118C. The processed emissions data can also be used to determine the value of the decarbonization project and initiatives, step 118D. The method can also include performing a physical and transitional risk assessment specific to different climate scenarios, such as, by simple way of example, assessing the impact of a selected increase in temperature, a selected increase in sea level, selected disruptions in the supply chain due to climate events, physical risks, or impact of a carbon tax imposed by governments, or technological or execution or financial risk associated to the transition of an enterprise to a low carbon economy, so as to evaluate and strategize the actions the enterprise needs to take to build an emissions resilience in the enterprise and to sustain or improve its financial performance, while concomitantly maintaining its market relevance, step 118E. This can be performed by the risk management unit 88.

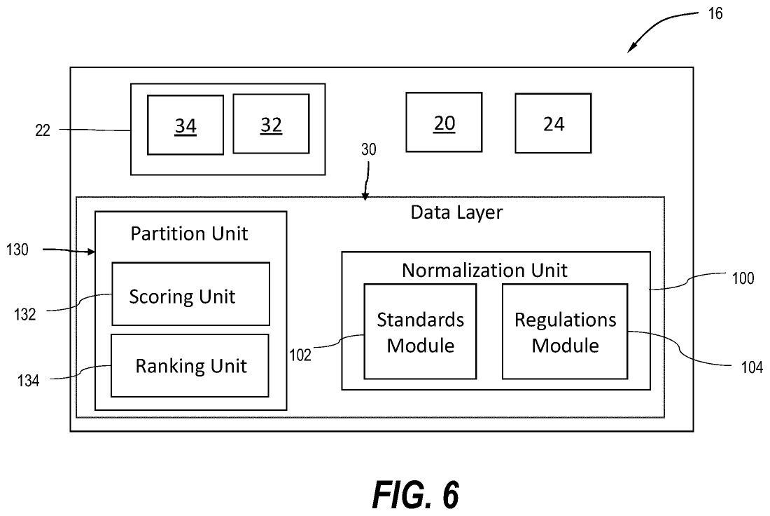

The data collection and processing system 10 of the present invention employs a data analysis module 16 for analyzing the data from the data sources 12, such as the environmental, financial, and non-financial data, as set forth above. The data analysis module 16 can employ, if desired, a partition unit 130 to virtually partition or segment the enterprise into a collection or series of clusters, as shown for example in FIGS. 6-8. The illustrated partition unit 130 can form part of the data layer 30 or can be separate therefrom. The partition unit 130 can form a plurality of clusters 142 that can be associated with one or more portions of the enterprise 140. As used herein, the term “cluster(s)” is intended to mean a portion of an enterprise and can include a building, a floor in a building, a collection of buildings, one or more selected types of equipment in the enterprise, selected systems associated with the equipment, one or more sub-systems of or associated with the equipment, and the like. The constituent elements or data sources associated with each cluster 142 can each have data attributes associated therewith, where the data attributes include environmental and non-environmental data captured from sensors and other information and operational technologies deployed by the enterprise as well as financial and non-financial data gathered from third party data sources (e.g., device and non-device sources), such as weather data, satellite data, drone data, risk scores, emission, carbon credit transactions, and the like. For example, as shown, the second cluster 142B can include a plurality of devices 146, including detectors, sensors, fans, heating or cooling equipment, and the like, that are connected together and which can communicate with external data, such as non-device data, to form a sensor network 144. The devices 146 are configured for generating environmental data, such as emissions data, and non-environmental data, such as specifications and identification tags, for subsequent processing by the data analysis module 16. The devices 146 in the sensor network 144 can selectively communicate with each other, depending upon the configuration of the overall network 144. The illustrated partition unit 130 can include a scoring unit 132 for determining a data attribute score associated with each connected device. The data attribute score can be a function of data from a number of other devices that are coupled to the selected device (e.g., device attribute data) in the network 144 or other sources of data provided to the network and that communicate with the device, such as weather data, satellite data, drone data, risk scores, emission information, and the like, or not associated with a connected device (e.g., non-device attribute data. As used herein, the term “attribute” is intended to mean data that describes other data, and is thus a descriptor of the various types of data. Thus, the attribute can be a way for data to describe other parts of data. Further, the selected device can be configured to generate environmental and/or non-environmental data that has an attribute associated therewith depending upon the type of device being employed. The attribute can include, for example, temperature, pressure, flow, fluid levels, air quality, humidity, moisture, and the like. The data attribute score thus corresponds to the number of device attributes available to verify, prove, or confirm the reliability of the data of the selected device. For example, the energy consumption data available from selected equipment can be scored using the different data attributes available from the location in which the equipment is operated, equipment runtime data attributes, maintenance records, relatable third party data, and the like.

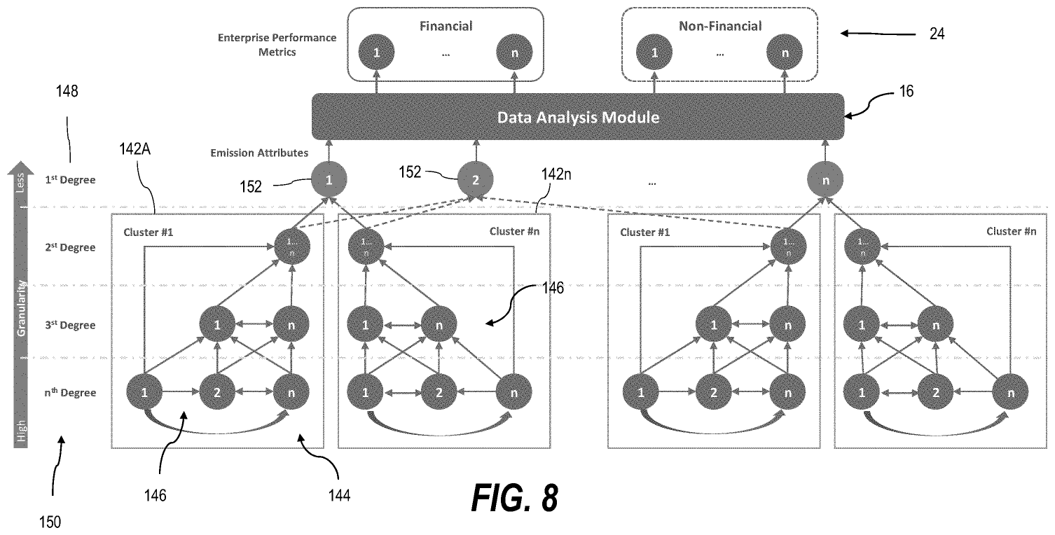

The illustrated partition unit 130 can also include a ranking unit 134 for ranking the devices in the sensor network 144 as a function of the data attribute score and as a function of a reliability of the data from the selected device. As used herein, the term “reliability” is intended to mean an overall consistency of the output data or reading of a device, where the consistency of the device output data (e.g., environmental data) can be determined or ascertained by checking or determining whether the output data of the device is within an expected range of output data over a selected period of time based on the output readings of the device, and optionally based on the output data from other connected devices and data sources in the sensor network 144. For example, a connected device can be a temperature sensor that can measure environmental data in an expected temperature range of between 0-100° C. If the device generates a reading within this range consistently over a period of time, after accounting for routine maintenance requirements, then the data associated therewith can be deemed to be reliable and hence the information can be processed by the data analysis module 16. If the device provides temperature readings outside of the expected range for a selected period of time, then the data can be deemed to be unreliable, and the data is not processed by the data analysis module 16. The data generated by the temperature sensor can also be checked or confirmed and scored by other devices and data sources connected to the temperature sensor or similar to the temperature sensor, if desired and if the network 144 is formed in such a manner. The ranking of the devices in the network 144 is shown for example in FIG. 8. By way of example, the cluster 142B has a collection of devices 146 associated therewith that forms the sensor network 144. The devices 146 can generate the environmental and/or non-environmental data of one or more systems of the enterprise, one or more subsystems in a system, components of the subsystems in a system, and the like, and each of the devices can be scored by the scoring unit 132 and ranked by the ranking unit 134. The system, subsystems in a system, and components of the subsystems in a system can be sorted into a number of tiers 148. The lower the tier 148 in the tier list 150, the fewer connections the selected device has to other devices in the network 144. The fewer the number of connections, the more difficult it is to verify the trustworthiness or reliability of the output data generated by the device using other devices. As the number of data connections increases, the selected device can be categorized in a higher tier level 148. The attribute data 152 associated with each of the devices or sensors in a specific sensor or device network 144 is then subsequently processed by the data analysis module 16. The attribute data 152 can be for example emissions attribute data. The data analysis module 16 can process the emissions data, as described above, and then pass the information to the post-processing unit 24 for generating one or more reports detailing enterprise performance metrics having financial data and non-financial data associated therewith.

The data collection and processing system 10 of the present invention can also employ an optional normalization module or unit 100 for normalizing the data received from either the data sources 12 or from the computing layer 18, as shown for example in FIG. 6. As used herein, the term “normalization” is intended to refer to a way for the enterprise to determine the absolute emissions of one or more clusters of the enterprise after accounting for other factors that may influence the context of the emissions estimate, such as for example, the age of the underlying asset, geolocation, the particular connection or arrangement of the systems in a cluster, and the like. The normalization unit 100 can thus contextualize the emissions performance or intensity of an enterprise or cluster(s) (e.g., cluster 142B) in an enterprise, or a system in a cluster, or a subsystem in a system, or a component of a subsystem in a system, relative to its design or operational capacity or size, in order to benchmark the historical emissions contributions of a cluster (e.g., cluster 142B) and to project performance into the future; to compare a cluster (e.g., cluster 142B) with other clusters of an enterprise that have similar system(s) or functional or operational specifications; to contextualize the emissions performance of an enterprise relative to its revenue size or assets or products contributing to the economic activity or regional operational; or to benchmark the emissions performance or intensity of an enterprise relative to the emissions performance or intensity of a similar enterprise. The normalization unit 100 can include a standards module 102 for applying to the data logic and rules associated with one or more industry standards that are relevant to the type of data, such as environmental or emissions data, being processed and analyzed by the system 10 so as to produce or generate standards data. For example, engineering, regulatory, and industrial standards can be applied to estimate the emissions footprint of selected equipment for a designed operating condition, such as for example temperature limits, pressure limits, speed, and the like, and can be applied to contextualize the emissions performance of the equipment relative to the operational conditions in which the equipment is deployed or relative to the age of the equipment for normalization. The normalized emissions associated with the selected equipment increases the fidelity or trustworthiness of the emissions estimate for the equipment and helps determine appropriate actions, such as maintenance, retrofitting, replacement, retirement, and the like, to reduce the emissions footprint of the enterprise. The normalization unit 100 can also include a regulations module 104 that can automatically apply to the data selected rules and logic associated with any selected legal, technical, regulatory or industry specific framework that is related or relevant to the data being processed thereby so as to produce regulation data. The framework can simply be a collection of related rules and logic. For example, when the enterprise earns carbon credits through carbon sequestration programs and wants to retire or apply the carbon credits towards the emissions of a selected cluster (e.g., cluster 142B) located in a specific country or region, the emissions value of the carbon credits can be normalized relative to regulatory guidelines underpinning the asset class of the carbon credit. The normalization can be in accordance with different regulations applicable to the country or region associated with the asset or asset class, so as to enable the enterprise to evaluate the cost of holding or exchanging such credits with other participants within the enterprise portfolio or between enterprises. The illustrated normalization unit 100 can form part of the data layer 30 or can be separate therefrom. The normalization unit 100 can process data received from the partition unit 130, and can also optionally process data from the computing layer 18 or from one or more components of the enrichment unit 22, including for example from the applications interface unit 32 and the cognitive intelligence unit 34.

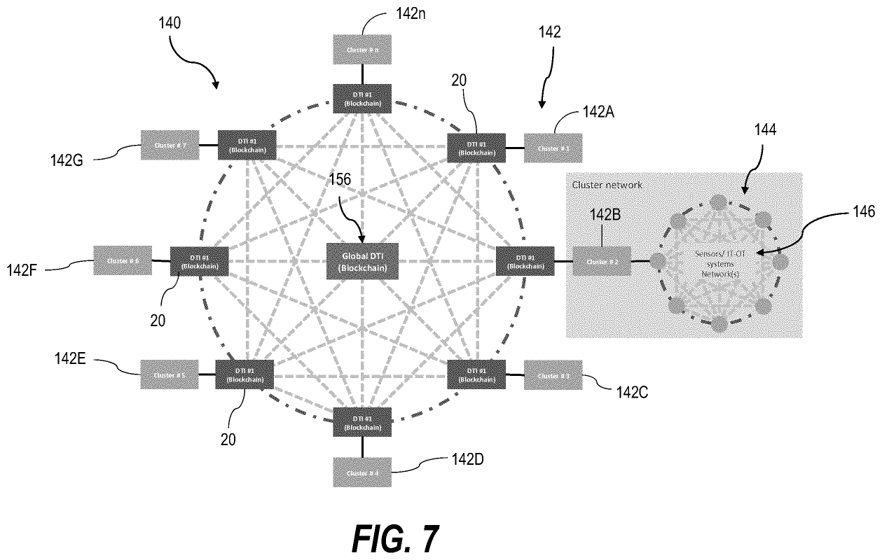

The data collection and processing system 10 can be employed to capture data from a diverse range of data sources, including for example from internal or external sources (e.g., device and non-device data sets), information technology (IT) and operational technology (OT) systems (e.g., supply chain management systems), transportation related information, enterprise resource planning related information, supervisory control and data acquisition (SCADA) control systems, manufacturing execution systems, weather data systems or sources, and the like. The system 10 can also store in appropriate memory or storage emissions related information, applicable standards and regulatory information, which can be stored in the standards module 102 and the regulatory module 104, respectively, natural resource consumption data, third party data 38, and the like. This data can be enriched by the enrichment unit 22 and the data can also optionally be mapped to regulatory and standards data. This information can then be stored in the block chain 20A of the digital trust infrastructure unit 20. Specifically, as shown in FIGS. 7 and 8, the sensor attribute data 152 from the sensor network 144 can be stored directly in the digital trust infrastructure (DTI) unit 20 that employs the blockchain 20A. According to one embodiment, each of the clusters 142 can employ a digital trust infrastructure unit 20 for storing the attribute data. The digital trust infrastructure units can be arranged into a larger network of digital trust infrastructure units.

The storage of the data in the blockchain 20A of the digital trust infrastructure unit 20 allows the data collection and processing system 10 to easily verify the data, the source of the data, and any actions performed on or by the data. The ability to determine the origins of the data and the flow of the data is known as data provenance. The digital trust infrastructure unit 20 can also be configured to employ smart contracts to store data in the block chain 20A. As used herein, the term “smart contract” is intended to mean executable computer code, logic or protocols that is stored in the blockchain 20A and which enables the system 10 to generate data for storage in the blockchain according to a predefined set of rules or when a set of predefined conditions occur. As such, the smart contract can process incoming data that satisfies the predefined rules and generates new information or facts that are added to a ledger of the blockchain. The smart contract thus enables the enterprises to transact business with each other according to a set of common defined terms, data, rules, concept definitions, and processes. Taken together, the smart contracts lay out the business model that govern all of the interactions between transacting clusters, enterprises, or parties. A smart contract thus defines the rules between different clusters, such as cluster 142B, or different enterprises, in executable code. Applications invoke a smart contract to generate transactions that are recorded on the ledger. Specifically, the smart contract implements the governance rules for any type of business object, so that they can be automatically enforced when the smart contract is executed. For example, a smart contract can ensure that a new car delivery is made within a specified timeframe, or that funds are released according to prearranged terms, improving the flow of goods or capital respectively. Most importantly, the execution of a smart contract is much more efficient than a manual human business process. The smart contracts can be grouped together to form a chaincode, which can be used by administrators to group together related smart contracts for deployment. In general, the smart contract defines the transaction logic that controls the lifecycle of a business object contained in a world state. The smart contract can then be packaged into a chaincode which is deployed to a blockchain 20A. As such, the smart contract can be considered to govern transactions, whereas chaincode governs how the smart contracts are packaged for subsequent deployment. One or more of the smart contracts can be defined within a chaincode. When the chaincode is deployed, all smart contracts within it are made available to applications. An example of a system suitable for generating or employing a smart contract in connection with documents is disclosed in U.S. Pat. No. 10,528,890, assigned to the assignee hereof, the contents of which are herein incorporated by reference.

At a basic level, the blockchain 20A immutably records transactions which update states in a ledger. The smart contract can programmatically access two distinct pieces of the blockchain ledger, namely, a blockchain, which immutably records the history of all transactions, and a world state that holds a cache of the current value of these states. The blockchain 20A is an immutable ledger of all transactions that have occurred, where every transaction is reflected as an object recorded to the blockchain in a discrete block. Each block of the chain contains an object key. Multiple transactions with the same object key can occur. The world state is in essence a database that sits on the blockchain and holds current values for a given object key. The world state changes over time as new transactions reference the same object key. As a result, the blockchain determines the world state, and the ledger is comprised of both the blockchain and the world state. The smart contracts primarily put, get and delete states in the world state, and can also query the immutable blockchain record of transactions. The “get” typically represents a query to retrieve information about the current state of a business object. The “put” typically creates a new business object or modifies an existing one in the ledger world state, and the “delete” typically represents the removal of a business object from the current state of the ledger, but not the history of the ledger.

Further, when the smart contract executes, the contract runs on a peer node that forms part of the blockchain network. The smart contract takes a set of input parameters called the transaction proposal and uses them in combination with program logic to read from and write to the ledger. Changes to the world state are captured as a transaction proposal response, which contains a read-write set with both the states that have been read, and the new states that are to be written if the transaction is valid. The world state is not updated when the smart contract is executed.

A drawback of conventional smart contracts is that once computer logic is created and stored on the blockchain, it is immutable and hence cannot be changed. The system 10 of the present invention can process, among other types of data, financial data. The financial data can be employed for auditing and tax purposes. Hence, one or more smart contracts can be employed to govern current tax laws for processing the financial data and creating one or more records for storage on the blockchain. However, tax laws and regulations, as well as associated validation criteria, may change over time. The information necessary to address a particular tax problem today, for example, may be insufficient to address for future tax laws. Additionally, the logic that applies laws, regulations, and validation criteria to transactions may need to be updated frequently. Blockchain in its current state is not configured to allow existing data objects to be updated with new attributes, while preserving the existing attributes and their values. Any updates to the smart contract logic currently requires a developer to recode and redeploy the smart contract on all nodes of the blockchain 20A.

As such, modularity in the blockchain design can allow for new service offerings to be added over time. Modularly designed smart contracts permit the addition of new attributes, which includes any types of data including metadata, without overwriting the old attributes on the blockchain. Current blockchain configurations overwrite old attributes on the chain. Modular smart contracts also preserve the privacy of attributes by only allowing the assigned party to access their own attributes as well as shared attributes, but not the attributes of other parties.

The present invention can also employ customizable smart contracts that allow for the addition of new processing criteria without the need to recode and redistribute the smart contracts to every node. By way of a simple example, current tax laws permit transaction costs to be written off for tax purposes for up to five years in the past. At some future point, this is updated to permit write offs of up to seven years in the past. Conventional smart contracts require the enterprise to recode all the smart contracts and redistribute them to all the nodes on the blockchain. The new rule would hence only apply to future transactions. The metadata associated with the smart contract can be stored dynamically in the blockchain ledger and in the world state. Rather than have processing rules hardcoded into the smart contract, the smart contracts can analyze the metadata for the rules and information about the attributes. The rules and information can include, for example, attribute values where the smart contracts are designed to reject an attribute if it does not meet a given criteria, and customizable business rules such that if a value does not satisfy the business rule, the transaction can be rejected. The smart contracts can thus be configured to reject the wrong data type. The smart contracts can also be configured to communicate with each other, thus making it faster and easier to update processing rules. The current data collection and processing system 10 can hence employ modular, customizable smart contracts, where the rules can be updated dynamically without hardcoding and without the need to redistribute them to all the nodes on the blockchain. An example of a modular, customizable smart contract that is employed by the data collection and processing system 10 of the present invention is disclosed in U.S. Pat. Nos. 11,100,501 and 11,100,502, assigned to the assignee hereof, the contents of which are herein incorporated by reference.

The digital trust infrastructure unit 20 can include a distributed ledger composed of a blockchain 20A and a world state database. The blockchain 20A provides an immutable ledger of all blockchain transactions that have occurred and every blockchain transaction is reflected as an object recorded to the blockchain in a block. The object can include, for example, a set of attributes and associated attribute values. Each block in the blockchain 20A may reference an object key that acts as an identifier for associated transactions referencing the same object key. The world state database sits on the blockchain 20A and holds the current values for a given object key. As such, the content of world state database changes over time as new transactions reference the same object key. In this way, the world state database can be regarded as a snapshot of the blockchain 20A that shows the current state and attribute values associated with a particular object key. As used herein, the term “object” or “data object” refers to an event, a series of events, a tangible or intangible asset, a service, a product, a commercial transaction such as a sale, an input, an interaction between two parties or entities, a performance, a liability, equity, calories, or other entity, object, action, or occurrence or combination thereof. As used herein, the term “attribute” generally refers to a characteristic or data that describes an aspect of the data object.

According to one embodiment of the present invention, a distributed ledger can be provided that includes modularly designed smart contracts that permit the addition of new attributes without overwriting the old attributes. The modular design of the smart contracts preserves, in a current version of the world state database, all data object-related attribute values provided to the blockchain, thus reflecting the current status of the data object, including all attributes and attribute values, in real time or near real time. As used herein, the term “data object” may refer to an event, a series of events, a tangible or intangible asset, a service, a product, a commercial transaction such as a sale, an input, an interaction between two parties or entities, a performance, a liability, equity, calories, or other entity, object, action, or occurrence or combination thereof. Of course, exemplary embodiments of the invention may involve defining data objects to reference many other types of actions, entities, or concepts. Because the smart contracts are modular in design, they enable the compilation of all party-specific attributes into the world state database without requiring any party to share its party-specific attributes with another party. Accordingly, modular smart contracts, as provided by preferred embodiments of the invention, preserve the privacy of attributes, preferably only allowing the assigned party to access their own attributes as well as shared attributes, but not the attributes of other parties. Transacting parties involved only submit their own attributes, and the smart contract logic determines what needs to be preserved in each new version of world state database. The modular smart contract logic preserves privacy requirements by controlling the information that may be submitted and/or viewed by each party involved in the transaction while preserving, in the current world state, all data object-related attribute values provided to the blockchain transaction log.

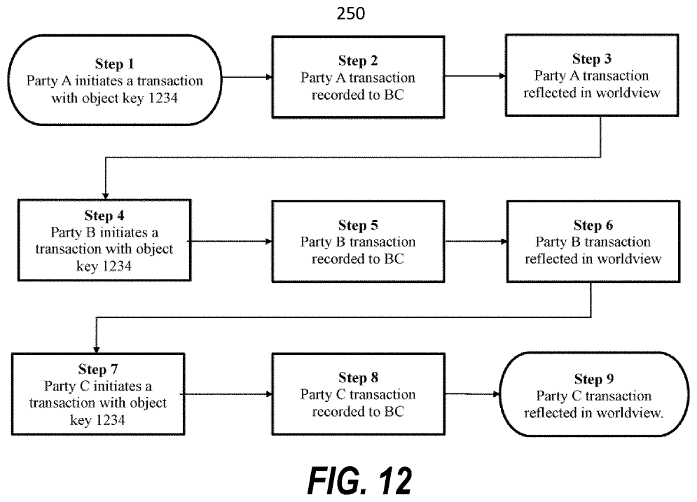

According to one example, a modular smart contract as shown in FIGS. 12-14 involve Parties A, B and C. Referring to the flowchart 250 in FIG. 12, at Step 1 Party A initiates a transaction with object key 1234. The Party A transaction is then recorded to blockchain (BC) at Step 2. A snapshot of the blockchain transaction log, reflecting the Party A transaction, is then recorded in the world state database at Step 3. Party B then initiates a transaction with object key 1234 at Step 4. Subsequently, at Steps 5 and 6, the Party B transaction is recorded in the blockchain and reflected in the new world state (new version of world state database) along with the transaction information from Party A. Similarly, when Party C initiates a transaction with object key 1234 at Step 7, the transaction information is recorded to the blockchain at Step 8 and reflected, along with transaction information from Party A and B, in the new world state (new version of world state data base) at step 9.

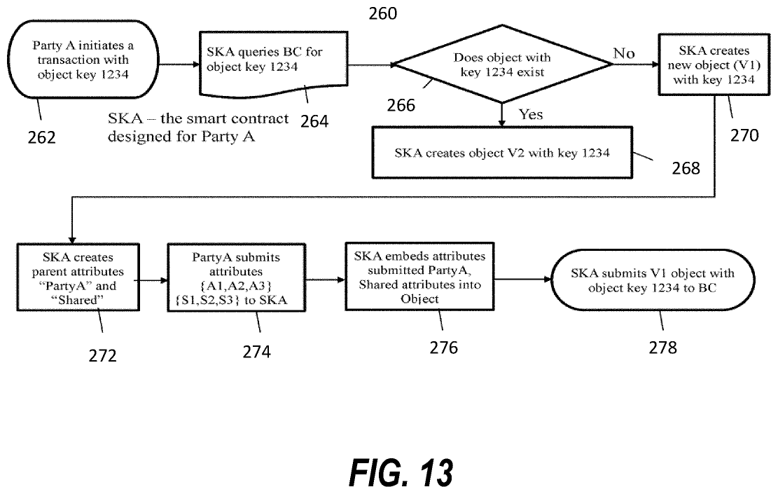

FIG. 13 illustrates an example of a process 260 involving the interaction of Party A with the modular smart contract for submitting transaction information to the blockchain according to one embodiment of the invention. The process starts at Step 262 when Party A initiates a transaction, to place a purchase order, with object key 1234. At Step 264, a modular smart contract designed for Party A (SKA) receives the transaction and object key 1234 and queries the blockchain for the object key 1234. At Step 266 the smart contract for Party A (SKA) determines whether a data object with object key 1234 exists in the blockchain. At Step 268, if a data object with object key 1234 already exists in the blockchain, the SKA pulls the corresponding attribute values for the data object from the current version of the world state database (Version 1) and creates a new version (Version 2) of the data object with object key 1234 that includes the Version 1 attributes. If no data object with object key 1234 is found in the blockchain in Step 266, the SKA creates a new data object (Version 1) with object key 1234 in Step 270.

At Step 272, the SKA creates a parent attribute, “Party A,” for storing values of private attributes provided by Party A, and a parent attribute, “Shared,” for storing shared attribute values provided by Party A. At Step 274, Party A submits its private attributes (A1, A2, A3) and the shared attributes (S1, S2, S3) to the SKA. At Step 276, the SKA embeds the party-specific attributes submitted by Party A and the shared attributes into the data object. In Step 278, the SKA submits the data object (Version 1) with object key 1234 to the blockchain.

Although the data object in the above example includes parent attributes, this is just one example of how to configure the data object. The modular design described herein does not require parent attributes. Those skilled in the art will appreciate that various configurations of the data object can be used with different embodiments of the invention. For example, the data object can be designed to have a flat structure with all attributes at the top level, or it could include a deep hierarchy with as many levels as desired.

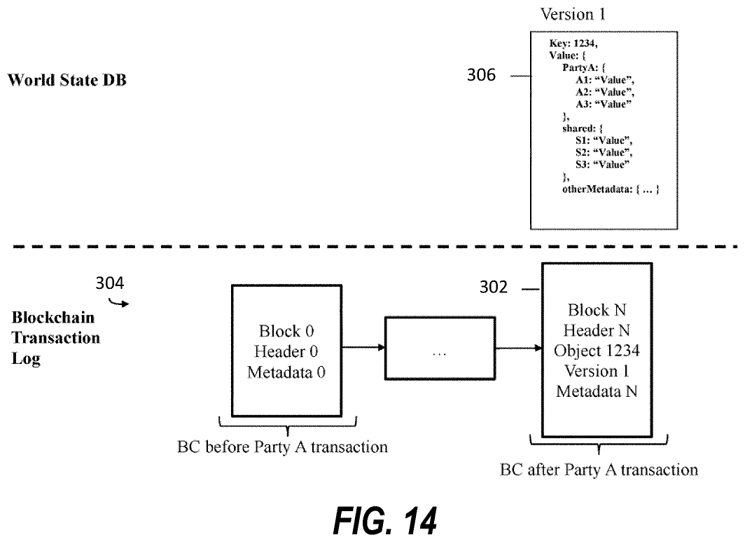

FIG. 14 illustrates the state of the distributed ledger after the Party A transaction information is submitted and recorded to the distributed ledger by the modular smart contract SKA, according to an exemplary embodiment of the present invention. The Party A transactional information is reflected in a data object referenced as Version 1 (V1) in a block 302 of the blockchain 304 (e.g., blockchain transaction log). Block 302 also contains the object key 1234. In addition to the blockchain transaction log 304, the distributed ledger also comprises a world state database 306 that holds the current attributes and attribute values associated with object key 1234 and provided by the SKA. Accordingly, following the Party A transaction, the world state database contains the transactional attributes for Party A (A1, A2, A3) and corresponding attribute values as well as the shared attributes (S1, S2, S3) and corresponding attribute values. In some embodiments the world state database may further include additional metadata, such as a version number of the data object, a timestamp that indicates when the current version was created or updated, an identity of the party and/or user who submitted the current version, etc.

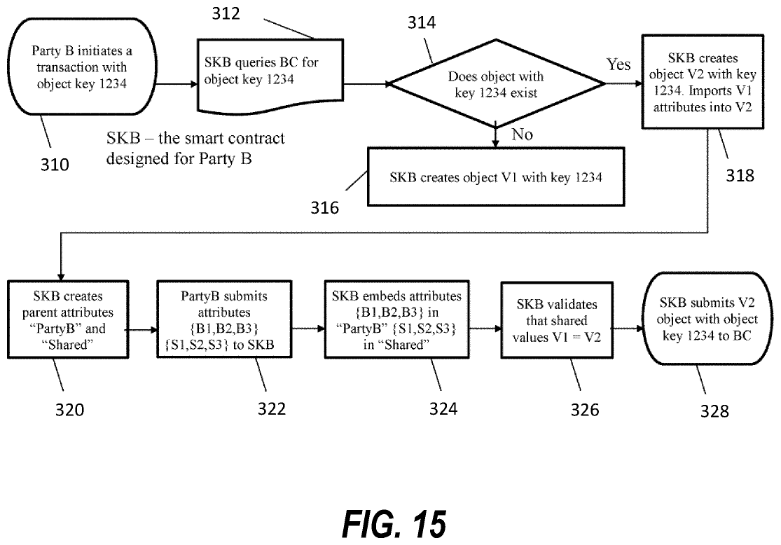

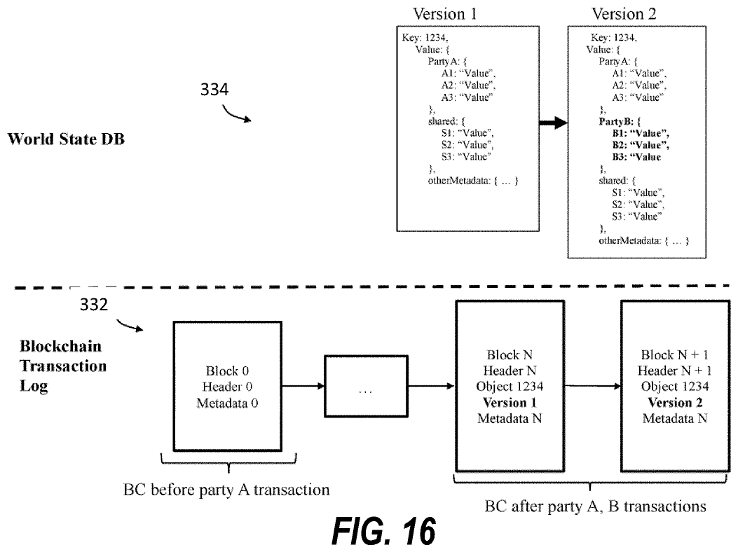

An example of the process involving the subsequent interaction of Party B with a modular smart contract for submitting transaction information to the blockchain-implemented ledger is illustrated in FIGS. 15-16. With reference to FIG. 15, the procedure begins at Step 310 when Party B initiates a transaction, to fulfill the purchase order placed by Party A according to this example. The transaction is assigned the same object key 1234. At Step 312, a modular smart contract designed for Party B (SKB) receives the transaction with object key 1234 and queries the associated blockchain transaction log to determine if the object key 1234 exists. At Step 314 the SKB determines whether a data object with object key 1234 exists in the blockchain. If no data object with object key 1234 is found in the blockchain, the SKB creates a new data object (Version 1) with object key 1234 in Step 316. However, if a data object (Version 1) with an object key 1234 already exists in a block of the blockchain, then the SKB creates Version 2 of the data object. In Step 318, the SKB pulls the corresponding attribute values for the data object from the current version of the world state database (Version 1) and creates a second version of the data object (Version 2) with object key 1234 which includes the Version 1 attributes. At Step 320, the SKB creates a parent attribute, “Party B,” for storing the private attributes (B1, B2, B3) and attribute values provided by Party B, and a parent attribute, “Shared,” for storing shared attribute values provided by Party B. At Step 322, Party B submits its private attributes (B1, B2, B3) and the shared attributes (S1, S2, S3) to the SKB. At Step 324, the SKB embeds attributes B1, B2 and B3 into parent attribute “Party B” and embeds the shared attributes S1, S2 and S3 into parent attribute “Shared.” At Step 326, the automated logic of SKB verifies that the shared attribute values (S1-S3) in data object Version 2 provided by Party B match the shared attribute values in data object Version 1 provided by Party A. If the shared attributes values match, the SKB submits object Version 2 with object key 1234 to the blockchain in Step 328.

According to one embodiment, pulling attribute values from a previous version of a data object that are associated with the same object key, and validation of data, occurs automatically through the automated logic of the modular smart contract. The automated logic of the modular smart contract, according to some embodiments, determines which attributes are new, which attributes are shared, and which attributes need to be retained in subsequent versions of the world state database.

The state of the distributed ledger after the Party B transaction information is submitted and recorded to the distributed ledger by the modular smart contract is depicted in FIG. 16, according to an exemplary embodiment of the invention. FIG. 16 illustrates the state of the distributed ledger after the Party A and Party B transactions are completed and the corresponding transactional information has been recorded to the distributed ledger through the modular smart contracts SKA and SKB, according to one embodiment of the invention. The Party A and Party B transactional information is reflected as data objects referenced as Version 1 (V1) and Version 2 (V2) in discrete blocks N and N+1 of the blockchain 332. Both blocks N and N+1 of the blockchain contain the object key 1234. Although the example in FIG. 16 shows Version 1 and Version 2 in discrete blocks N and N+1, respectively, in other embodiments, multiple blockchain transactions can be stored in a single block of the blockchain.

In addition to the blockchain 704, the distributed ledger in FIG. 16 also comprises a world state database 334 that holds the current attributes and attribute values associated with object key 1234 as provided by SKA and SKB. Accordingly, Version 1 of the world state database, created following the Party A transaction, contains the data object-related attributes (A1, A2, A3) for Party A and corresponding attribute values, as well as the shared attributes (S1, S2, S3) and corresponding attributes values. Version 2 of the world state database, created following the Party B transaction, contains the data object-related attributes (B1, B2, B3) for Party B and the corresponding attribute values as well as the shared attributes (S1, S2, S3) while also retaining the data object-related attributes and attribute values of Party A. The modular smart contract SKB captures the data object-related information (e.g., attributes and attribute values) from Party B while preserving Party A attributes and attribute values in Version 2 of the world state database. According to one example, the world state database cam be configured to only retain the latest version at any given time. In this example, the world state database only holds Version 2 (the latest version), while the blockchain transaction log retains all the versions (1 and 2). According to an embodiment, shared attributes propagate across developing versions of the world state database. In some embodiments, the world state database may further include additional metadata, as described above.

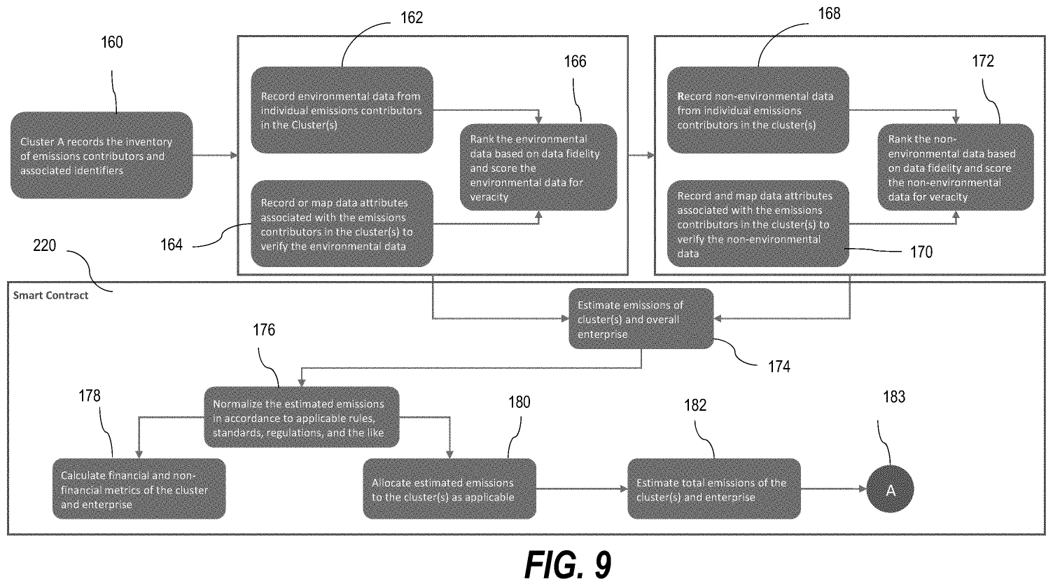

The present invention is also directed to a climate accounting method for estimating and proving emissions readings associated with an enterprise having a one or more virtual or physical clusters associated therewith. The method of the present invention is shown for example in FIGS. 9-11. According to the present invention, the method initially determines the number and types of emission sources (e.g., emission contributors) associated with a specific cluster (e.g., cluster 142A) and then records this information to form an inventory of emission contributors on the blockchain 20A, step 160. The emissions data (e.g., environmental data) of each of the emission contributors in the inventory list associated with each cluster 142A is then determined and recorded, step 162. The system 10 can also determine the emissions data associated with a set of emissions contributors within a different cluster (e.g., cluster 142B) or from third party sources 110F. The emissions data of each of the emission contributors has attribute data associated therewith. The emission contributors correspond in a sense to data objects in a data model, and each data object has attribute data associated therewith. The attribute data is information about the data object. In the current example, the data objects can correspond to sensors, detectors, transportation, manufacturing, and the like, and the attribute data can be an identification of the types of sensor, location of the sensor, readings associated with the sensor, the purpose of the measurement, operational limits, quality, type of fuel, and the like. As previously noted, the attributes associated with the data can depend upon the type of device being employed, and can include devices for measuring temperature, pressure, flow, fluid levels, air quality, humidity, moisture, and the like. The device attribute data, which can include environmental information such as emission data, of the emission contributors of one or more of the clusters are recorded and then the data attributes from the clusters or other sources internal or external to the clusters (e.g, third party data in 110F) are used to verify the environmental data of the individual emission contributors. The environmental data from the emission contributors of one or more of the clusters and the attribute data associated with the emission contributors of the clusters can be processed by the partition unit 130 to improve the fidelity or reliability of the environmental data, step 164. Specifically, the scoring unit 132 scores the environmental data from the cluster by determining the number of attributes available in any associated cluster (e.g., clusters 142A and 142B), or outside of the cluster (e.g., third party in 110F), that can be used to verify or prove the data. The scoring information is then processed by the ranking unit 134 to rank the emission contributors and associated environmental data based on data quality and the like, step 166. This results in high fidelity environmental data that can be used to estimate the emissions of the clusters in an enterprise and the overall emissions of the enterprise.

The system 10 can also receive, process and store non-environmental data, such as financial data and non-financial data, received from individual emission contributors in one or more of the clusters, step 168. The system 10 can also record the data attributes associated with the non-environmental data to verify the non-environmental data of the emission contributors, step 170. The non-environmental data and the attribute data of the non-environmental data is then used to produce high fidelity non-environmental data. The non-environmental data is then scored using the scoring unit 132 to determine data veracity, and the non-environmental data is then ranked using the ranking unit 134 based on the data fidelity or veracity, step 172. The high fidelity environmental data and the high fidelity non-environmental data are then used to determine an estimate of the emissions of one or more of the clusters in the enterprise and the overall enterprise, step 174. The emissions estimate data is then processed by the normalization unit 100 so as to normalize the emissions estimate data, step 176. Specifically, the emissions estimate data can be processed by the standards module 102, which applies rules and logic associated with any relevant industry standard to the emissions estimate data. The resultant data is then processed by the regulations module 104, which applies logic and rules associated with any applicable regulations that apply to one or more of the clusters in the enterprise and the overall enterprise. The normalization unit 100 thus generates normalized emissions data associated with the clusters and the enterprise. The equations used to estimate emissions for the cluster(s) and enterprise can be summarized as

TEᵢ=Σⱼ₌₁ⁿ=SCⱼ

SCⱼ=Σᵢ₌₁ⁿ(Σₐ₌₁ⁿSEₐᵢ)

SEₐᵢ=Σₐ₌₁ⁿ(RCₐᵢ×Bₐᵢ×Pₐᵢ×t×Σₖ₌₁ⁿEFₖ))

RCₐᵢ=Σₛₐ₌₁ⁿ(RCSₐᵢ×Bₐᵢ×Pₐᵢ×t)

where i is the cluster identified under operational boundary of an enterprise for climate accounting, TEᵢ is the estimated total emissions in the cluster i in the operational boundaries of the cluster(s) of an enterprise; j is the emission categories per the guidelines formulated by industry standards board or industry task force or regulator or others; and SCⱼ is the emissions estimated by category in the cluster i per the guidelines formulated by industry standards board or industry task force or regulators or others; a is the devices (electrical or mechanical equipment, or structural or fleets or facilities or others) identified in the cluster i under the operational boundary of an enterprise; Skᵢ is the emissions from the built and operated system ‘a’ in the cluster i within the operational boundary of an enterprise and its suppliers; RCₐᵢ is the natural resources consumed by each of the built and operated system ‘a’ in the cluster i in the operational boundary of an enterprise and its suppliers; Pₐᵢ is the productivity of the built and operated system ‘a’ in the cluster i in the operational boundary of an enterprise and its suppliers; Bₐᵢ is the baseline for the natural resources consumed by the built and operated system ‘a’ at cluster i in the operational boundary of an enterprise and its suppliers; t is the time the built and operated system ‘a’ in cluster i in the operational boundary of an enterprise and its suppliers is operated to produce goods or services; RCSₐᵢ is the natural resources consumed by any subsystem or the component systems in the built and operated system ‘a’ in the cluster i in the operational boundary of an enterprise and its suppliers; K is the number of greenhouse gases in a natural resource consumed by the built and operated system ‘a’ and any of its subsystem or component systems in the cluster i in the operational boundary of an enterprise and its suppliers; and EFₖ is an emissions intensity factor for the specific natural resources consumed by the built and operated system ‘a’ and any of its subsystem or component systems in the cluster i.

The system can be configured to calculate the financial and non-financial metrics associated with the normalized estimated emissions data for the clusters and the enterprise, with the financial and non-financial data attributes associated with the emission contributors using the data analysis module 16, step 178. Further, the system can also be configured to allocate estimated emissions to applicable clusters of an enterprise or to one or more enterprises, step 180. The equation to estimate the normalized emissions of the cluster and the enterprise can be summarized as

$$T E = {\sum }_{i = 1}^{n} T {E}_{i} \times E A {F}_{i}$$

where TE is the normalized estimated emissions of the enterprise and EAFᵢ is the allocation factor used to normalize the estimated emissions in the cluster i within the operational boundaries of an enterprise. Once the allocation occurs, the system 10 can determine or calculate the total estimated emissions of the enterprise, step 182. The steps 174-182, and which involve estimating the emissions of the clusters or enterprise, normalizing the estimated emissions data, calculating the financial and non-financial metrics for the enterprise, and then determining the total estimated emissions, can be performed by a smart contract 220 that is associated with the digital trust infrastructure unit 20.

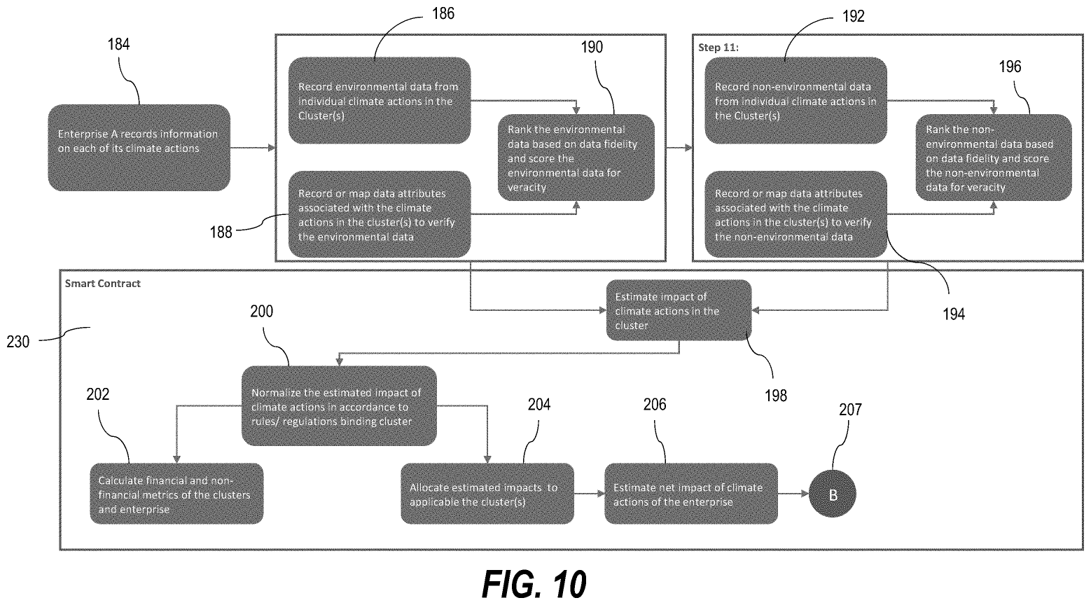

The data collection and processing system 10 and associated method of the present invention can also determine or calculate the net impact of climate actions taken or performed by the enterprise. For example, as shown in FIG. 10, the enterprise, such as enterprise A, can provide information to the system about each of the climate actions that the enterprise is potentially interested in pursuing, step 184. As used herein, the term “net impact” is intended to mean the sum of the enterprise's positive and negative impacts on one or more areas, such as the environment, health, society and knowledge. In other words, every enterprise uses resources (negative impact) and exists to create positive value (positive impact) with them. The sum of the positive and negative impacts is called the net impact. As used herein, the term “climate action” is intended to mean any action taken by the enterprise or associated third parties that changes, varies, or alters the emissions amount or profile of the enterprise. Examples of suitable climate actions include reducing the consumption of natural resources, deploying renewable energy, retrofitting one or more systems or devices to consume less energy, deploying or replacing existing devices with more energy efficient devices, reducing the scale or scope of operations, and the like. The system 10 can be configured to record the environmental data associated with each climate action pursued by the enterprise or by a contracted third party in the clusters, step 186. The system then can process and record the emission data attributes associated with each emission contributors and/or climate action performed so as to verify the environmental data of each climate action of the cluster or the enterprise, step 188. That is, the system verifies the emissions attributes of each climate action taken by the enterprise for a selected cluster. The environmental data (e.g., emission data) of each climate action taken by the enterprise is processed by the partition unit 130 to improve the fidelity or veracity of the environmental data, step 190. Specifically, the scoring unit 132 scores the environmental data from the enterprise A by determining the number of attributes available in any associated device that can be used to verify or prove the data. The scoring information is then processed by the ranking unit 134 to rank the emission contributors and associated environmental data based on data quality and the like for each of the climate actions taken by the enterprise for the cluster. This results in high fidelity environmental data that can be used to estimate the emissions impact of each of the climate actions taken in a cluster of the enterprise or the overall enterprise.

Further, the system 10 can also receive, process and store non-environmental data associated with each climate action taken by the enterprise A or contracted enterprise B, step 192. The system 10 can also record the data attributes associated with each of the climate actions so as to verify non-environmental data of each climate action taken by a cluster of the enterprise, step 194. The non-environmental data and the attribute data is then used to produce high fidelity non-environmental data, step 196. The high fidelity environmental data and the high fidelity non-environmental data is then used to estimate a climate impact of the climate actions taken by enterprise A, step 198. The equation used to estimate emissions impact of the different climate actions of the cluster and enterprise can be summarized as:

$$E {R}_{i} = {Σ}_{p = 1}^{n} ( P {E}_{p} - E {S}_{p} ) \times {D}_{p} \times \frac{{I}_{p}}{T {C}_{p}}$$

where p is the climate action projects executed in the cluster i within the operational boundary of an enterprise and its suppliers; PEₚ is the emissions impact of a climate action project executed in the cluster i within the operational boundary of an enterprise and its suppliers; ESₚ is the emissions savings of a climate action project executed in the cluster i within the operational boundary of an enterprise and its suppliers; Dₚ is the discount factor assigned to a climate action project per the guidelines established by regulatory or industry body specific to the cluster i within the operational boundary of an enterprise and its suppliers; Iₚ is the value of the investment made by an enterprise in a climate action project executed at the cluster i within the operational boundary of an enterprise and its suppliers; TCₚ is the total value of the climate action project executed at the unit i in the operational boundary of an enterprise and its suppliers. The climate action estimate data is then processed by the normalization unit 100 so as to normalize the climate action estimate data, step 200. Specifically, the climate action estimate data can be processed by the standards module 102, which applies rules and logic associated with any relevant industry standard to the climate action estimate data. The resultant data is then processed by the regulations module 104, which applies logic and rules associated with any applicable regulations that apply to the enterprise A. The normalization unit 100 thus generates normalized climate impact data associated with the enterprise A. The system can also be configured to calculate or determine the financial and non-financial metrics associated with the normalized climate impact data for the enterprise with the financial and non-financial data attributes associated with the emission contributors using the data analysis module 16, step 202. Further, the system 10 can also be configured to allocate the estimated climate impact data to applicable enterprises, step 204. The equation to estimate the normalized emissions of the cluster and the enterprise can be summarized as

$$E R = {\sum }_{i = 1}^{n} E {R}_{i} \times {CAF}_{i}$$

where ER is the normalized emissions impact of the climate action taken by the enterprise and CAFᵢ is the allocation factor used to normalize the emissions impact of each climate action take in the cluster i. Once the allocation occurs, the system 10 can determine or calculate the total estimated net impact of the climate actions of enterprise A, step 206. The steps 198-206, and which involve estimating the impact of the climate actions of the enterprise, normalizing the climate action estimate data, calculating the financial and non-financial metrics for the enterprise, and then determining the net impact of the climate actions, can be performed by a smart contract 230 that is associated with the digital trust infrastructure unit 20.

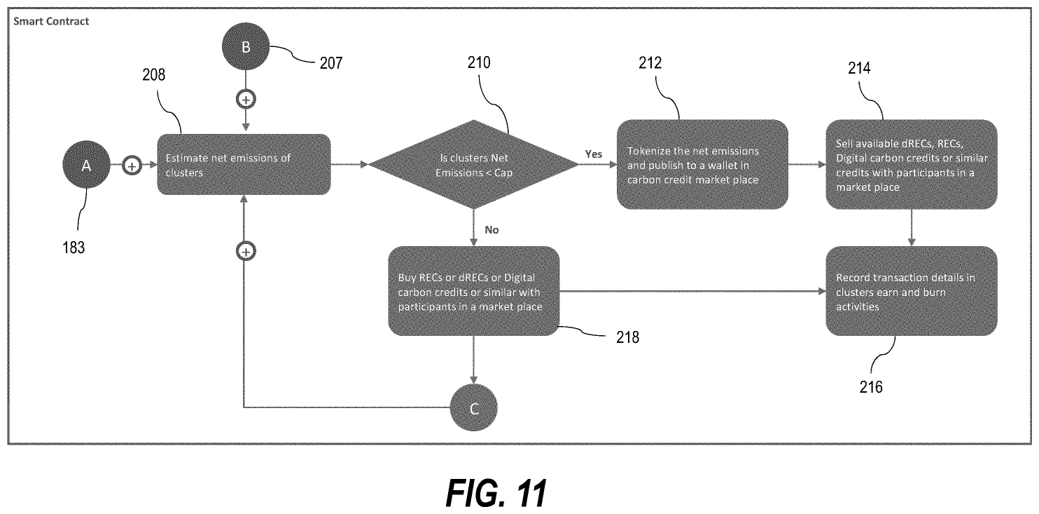

As shown in FIG. 11, the estimate of the total emissions of the enterprise 183 and the estimate of the net impact of the climate actions of the enterprise 207 can be utilized by the system to estimate the net emissions of the enterprise (e.g., enterprise A), step 208. The system 10 can compare the net emission amounts to a threshold level, such as a cap level, established for the individual clusters within the operational boundaries of an enterprise in accordance with one or more sustainability development target initiatives (SBTi) or enterprise determined climate or decarbonization goals, step 210. If the net emission total or amounts are less than a cap level, then the difference between the threshold and the net amounts can be tokenized, such as by the token creation unit 60, to create a carbon credit, step 212. The tokens can be published, if desired, to a carbon credit marketplace for sale by the enterprise. The tokenized carbon credit can be sold to another enterprise through the marketplace or directly thereto, step 214. The transaction details associated with the sale of the carbon credit can be recorded, such as to the blockchain 20A, step 216. The equation to estimate the emissions impact of the carbon credits exchanged by the enterprise can be summarized as:

EOᵢ=Σₒ₌₁ⁿVOₒ×EUₒ×C

where o is the offsets type (e.g., carbon credits, renewable energy certificates, emissions reduction credits, and the likes) exchanged by the cluster i in the operational boundary of an enterprise and its suppliers; VOₒ is the volume of offsets acquired for the cluster i in the operational boundary of an enterprise and its suppliers; EUₒ is the emissions equivalent of an offset as determined by the regulators or as defined by the applicable standards board or task force for the cluster i in the operational boundary of an enterprise and its suppliers; and C is the constant used to discount the different class of offsets exchanged by the cluster i within the operational boundaries of the enterprise in accordance with constraints determined for a specific class of offsets. Further, the following equation can also be employed to determine the normalized emissions:

$$EO = {\sum }_{i = 1}^{n} {EO}_{i} \times O A {F}_{i}$$

where EO is the overall normalized emissions offsets (e.g., RECs, dRECs, ERC, etc.) accrued by the cluster through various climate actions such as energy transition, adaptation and energy emissions reduction or other similar in collaboration with an enterprise and its suppliers, and OAF is the allocation factor used to normalize the emissions offsets in the cluster i within the operational boundaries of an enterprise. If the net emissions is greater than the cap level, then the enterprise can seek to purchase carbon credits in the marketplace, step 218. The transaction details can also be recorded in the blockchain, step 216.

The data collection and processing system 10 of the present invention can thus be employed to determine the emissions footprint of an enterprise. To that end, the system 10 can determine the emissions inventory of the enterprise or one or more clusters of the enterprise. The system can also estimate the emissions across various categories, as well as determine the impact on emissions of any climate actions. When this information is determined, the system can track the performance of the enterprise of any associated climate goals, and the post-processing unit 24 can be employed to handle any financial disclosures or reports that may need to be generated. The equation to estimate the overall emissions of the enterprise can be summarized as

NE=(TE+ER+EO)×DFᵢ

where NE is the net emissions of the enterprise, and DFᵢ is the discount factor applied to express the net emissions of an enterprise in the context of evaluation, benchmarking, and the like, relative to industry standards or other enterprises.

The system 10 of the present invention can also be employed to provide recommendations for the clusters and enterprise with regard to emissions and the type and scope of climate actions may need to be taken. This information can be utilized by the system when tracking financial performance of the enterprise. The system can also help forecast, based on the estimated emissions data and third party data, the impact of any selected climate risks on the enterprise.

It is to be understood that although the invention has been described above in terms of particular embodiments, the foregoing embodiments are provided as illustrative only, and do not limit or define the scope of the invention. Various other embodiments, including but not limited to those described herein are also within the scope of the claims. For example, elements, units, tools and components described herein may be further divided into additional components or joined together to form fewer components for performing the same functions. Further, the above described windows or screens can be generated by any selected portion or unit of the system 10, such as for example, by the post-processing unit 24. The system can also employ any selected portion or unit of the illustrated system 10 to generate the reports set forth herein, such as for example, by the post-processing unit 24.

Any of the functions disclosed herein may be implemented using means for performing those functions. Such means include, but are not limited to, any of the components disclosed herein, such as the electronic or computing device components described herein. That is, any unit or module of the illustrated data collection and processing system 10 can be implemented by using one or more of the electronic or computing devices disclosed herein.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The term computing device or electronic device can refer to any device that includes a processor and a computer-readable memory capable of storing computer-readable instructions, and in which the processor is capable of executing the computer-readable instructions in the memory. The terms computer system and computing system refer herein to a system containing one or more computing or electronic devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require a computer, a processor, a memory, or similar computer-related elements are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to process and then enrich environmental data, and store the enriched environmental data along with other data in a digital trust infrastructure unit 20, such as in a blockchain. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program or computer readable product tangibly embodied in a machine-readable storage device for execution by a computer processor. Method steps of the invention may be performed by one or more computer processors executing one or more programs tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

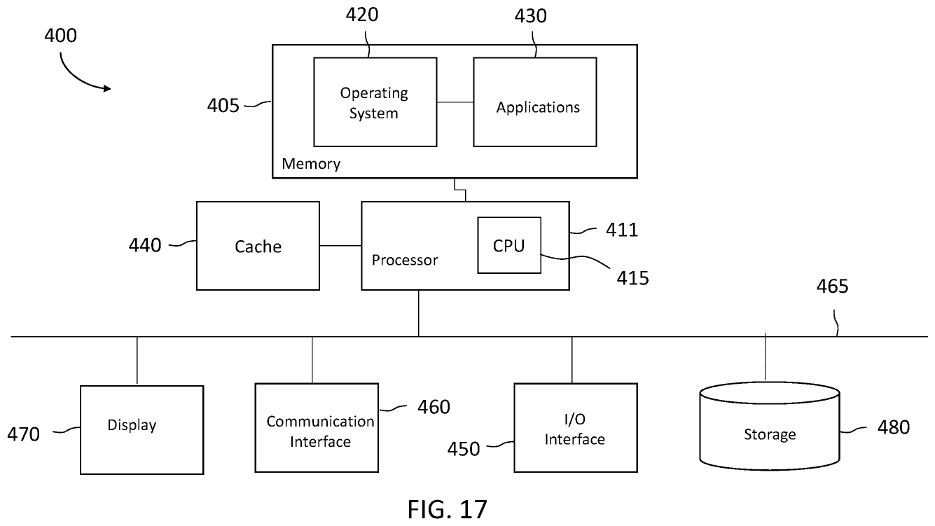

It should be appreciated that various concepts, systems and methods described above can be implemented in any number of ways, as the disclosed concepts are not limited to any particular manner of implementation or system configuration. Examples of specific implementations and applications are discussed below and shown in FIG. 17 primarily for illustrative purposes and for providing or describing the operating environment of the system of the present invention. The data collection and processing system 10 and/or any elements, components, or units thereof can employ one or more electronic or computing devices, such as one or more servers, clients, computers, laptops, smartphones and the like, that are networked together or which are arranged so as to effectively communicate with each other. The network (such as network 14) can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the electronic or computing device 400. The present invention can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 400. In one embodiment, the server may be referred to as a remote machine or a node. In another embodiment, a plurality of nodes may be in the path between any two communicating servers or clients. The data collection and processing system 10 which includes for example the computing layer 18, the enrichment unit 22, the digital trust infrastructure unit 20, the post-processing unit 24, the data layer 30, the applications interface unit 32, and the cognitive intelligence unit 34, the normalization unit 100, and the partition unit 130 can be stored in or on or be implemented by one or more of the clients or servers, and the hardware associated with the client or server, such as the processor or CPU, memory, storage and the like described herein.

FIG. 17 is a high-level block diagram of an electronic or computing device 400 that can be used with the embodiments disclosed herein of the data collection and processing system 10 of the present invention. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 400 can be any suitable electronic circuitry that includes a main memory unit 405 that is connected to a processor 411 having a CPU 415 and a cache unit 440 configured to store copies of the data from the most frequently used main memory 405. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 411 is any logic circuitry that responds to, processes or manipulates instructions received from the main memory unit, and can be any suitable processor for execution of a computer program. For example, the processor 411 can be a general and/or special purpose microprocessor and/or a processor of a digital computer. The CPU 415 can be any suitable processing unit known in the art. For example, the CPU 415 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 411 can be embodied in any suitable manner. For example, the processor 411 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 411 can be configured to execute instructions stored in the memory 405 or otherwise accessible to the processor 411. As such, whether configured by hardware or software methods, or by a combination thereof, the processor 411 can represent an entity (e.g., physically embodied in circuitry) capable of performing operations according to embodiments disclosed herein while configured accordingly. Thus, for example, when the processor 411 is embodied as an ASIC, FPGA or the like, the processor 411 can be specifically configured hardware for conducting the operations described herein. Alternatively, as another example, when the processor 411 is embodied as an executor of software instructions, the instructions can specifically configure the processor 411 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 405.

The electronic device 400 applicable to the hardware of the present invention can be based on any of these processors, or any other processor capable of operating as described herein. The central processing unit 415 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 411 and the CPU 415 can be configured to receive instructions and data from the main memory 405 (e.g., a read-only memory or a random access memory or both) and execute the instructions The instructions and other data can be stored in the main memory 405. The processor 411 and the main memory 405 can be included in or supplemented by special purpose logic circuitry. The main memory unit 405 can include one or more memory chips capable of storing data and allowing any storage location to be directly accessed by the processor 411. The main memory unit 405 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 405 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 405 can be based on any of the above described memory chips, or any other available memory chips capable of operating as described herein. In the embodiment shown in FIG. 17, the processor 411 communicates with main memory 405 via a system bus 465. The computer executable instructions of the present invention may be provided using any computer-readable media that is accessible by the computing or electronic device 400. Computer-readable media may include, for example, the computer memory or storage unit 405. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 405 is shown within the computing device 400 it will be appreciated that the storage may be distributed or located remotely and accessed via a network or other communication link.

The main memory 405 can comprise an operating system 420 that is configured to implement various operating system functions. For example, the operating system 420 can be responsible for controlling access to various devices, memory management, and/or implementing various functions of the asset management system disclosed herein. Generally, the operating system 420 can be any suitable system software that can manage computer hardware and software resources and provide common services for computer programs.

The main memory 405 can also hold application software 430. For example, the main memory 405 and application software 430 can include various computer executable instructions, application software, and data structures, such as computer executable instructions and data structures that implement various aspects of the embodiments described herein. For example, the main memory 405 and application software 430 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 411 can further be coupled to a database or data storage 480. The data storage 480 can be configured to store information and data relating to various functions and operations of the content characterization systems disclosed herein. For example, as detailed above, the data storage 480 can store information including but not limited to captured information, multimedia, processed information, and characterized content.

A wide variety of I/O devices may be present in or connected to the electronic device 400. For example, the electronic device can include a display 470, and as previously described, the data collection and processing system 10 can include the display. The display 470 can be configured to display information and instructions received from the processor 411. Further, the display 470 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 470 can be a smart and/or touch sensitive display that can receive instructions from a user and forwarded the received information to the processor 411. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 400 can also include an Input/Output (I/O) interface 450 that is configured to connect the processor 411 to various interfaces via an input/output (I/O) device interface 480. The device 400 can also include a communications interface 460 that is responsible for providing the circuitry 400 with a connection to a communications network (e.g., communications network 120). Transmission and reception of data and instructions can occur over the communications network.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A data collection and processing system, comprising
a plurality of data sources for generating environmental data from one or more enterprises,
a data analysis module for receiving the environmental data from the plurality of data sources, wherein the data analysis module includes
an enrichment unit for storing and enriching the environmental data from the plurality of data sources to form enriched environmental data, wherein the enrichment unit includes a financial subsystem for analyzing and processing the environmental data and for generating financial data and non-financial data therefrom,
a digital trust infrastructure unit for storing the financial data and the non-financial data, the enriched environmental data or the environmental data is stored in the data layer in a secure and verifiable format, wherein the digital trust infrastructure unit employs a blockchain for storing any combination of the environmental data, the enriched environmental data, and the financial data, and
a post-processing unit for processing the environmental data and the financial data stored in the digital trust infrastructure so as to generate one or more reports from the environmental data and the financial data,
wherein the plurality of data sources includes a plurality of devices coupled to one or more structures of the enterprise for measuring one or more selected parameters thereof to form the environmental data, and pre-stored data including data from data libraries related to the parameters being measured by the plurality of devices,
wherein the enrichment unit comprises
a data layer for storing the environmental data from the plurality of data sources, wherein the data layer includes
a partition unit for virtually segmenting the enterprise into a plurality of clusters, wherein each of the plurality of clusters has associated therewith one or more of the plurality of devices for generating the environmental data, and
a normalization unit for normalizing the environmental data from the plurality of devices for each of the plurality of clusters,
an applications interface unit having an application unit for storing one or more software applications for processing the environmental data in the data layer, and a third party data unit for storing third party data that is related to the environmental data stored in the data layer, and
a cognitive intelligence unit for applying one or more pre-defined intelligence techniques to the environmental data so as to process and enrich the environmental data to form the enriched environmental data, wherein the cognitive intelligence unit includes a recommendation engine for applying a machine learning technique to the environmental data from the data layer to generate predictions based on the environmental data.

2. The data collection and processing system of claim 1, wherein the one or more devices are configured to generate the environmental data and has one or more attributes associated therewith.

3. The data collection and processing system of claim 2, wherein one or more of the plurality of devices comprises one or more sensors.

4. The data collection and processing system of claim 2, wherein the partition unit comprises
a scoring unit for determining based on the environmental data generated by the one or more devices a data attribute score associated with each device, wherein the data attribute score corresponds to the number of attributes associated with each device, and
a ranking unit for ranking the devices based on the data attribute score.

5. The data collection and processing system of claim 4, wherein the ranking unit is configured to rank the devices based on a reliability of the device.

6. The data collection and processing system of claim 5, wherein the ranking unit is configured to check the reliability of the device by analyzing output data of the devices over a selected period of time and by comparing the output data to a preselected device output data range.

7. The data collection and processing system of claim 6, wherein the ranking unit is configured to determine the reliability of the device based on the output data generated by one or more additional devices.

8. The data collection and processing system of claim 7, wherein the plurality of data sources correspond to a plurality of devices arranged in a device network, and wherein the ranking unit is configured to arrange each of the plurality of devices into a plurality of logical tiers based on a number of physical connections to the remaining devices in the device network.

9. The data collection and processing system of claim 8, wherein the normalization unit can be configured to contextualize the environmental data associated with one or more clusters of the enterprise or one or more portions of one or more clusters of the enterprise.

10. The data collection and processing system of claim 9, wherein the normalization unit is configured to compare the environmental data from one of the plurality of clusters with one or more other clusters of the plurality of clusters employing similar devices.

11. The data collection and processing system of claim 10, wherein the normalization unit comprises
a standards module for applying to the environmental data one or more rules associated with one or more standards associated with the environmental data so as to generate standards data, wherein the standards module applies the standard to the environmental data so as to estimate an emissions footprint of one or more clusters of the plurality of clusters, and
a regulations module for applying to the environmental data one or more rules associated with a selected framework that is associated with the environmental data being processed by the normalization unit so as to produce regulation data.

12. The data collection and processing system of claim 11, wherein the standards module is configured when applying the rules to the environmental data to determine an emissions footprint of the enterprise.

13. The data collection and processing system of claim 1, wherein the pre-defined intelligence techniques include one or more of a machine learning technique, an artificial intelligence technique, a natural language processing technique, neural networks, statistical techniques, and a risk modelling technique.

14. The data collection and processing system of claim 12, wherein the third party data comprises one or more of weather data, occupancy data, satellite data, optical data, physical enterprise data, maintenance related data, equipment related data, spatial related data associated with structures, enterprise data, and asset management related data.

15. The data collection and processing system of claim 1, further comprising a computing layer for storing the data from the plurality of data sources prior to storing the data in the data layer.

16. The data collection and processing system of claim 14, wherein the cognitive intelligence unit further comprises a risk model unit for applying one or more risk modelling techniques to the environmental data from the data layer.

17. The data collection and processing system of claim 16, wherein the risk model unit and the recommendation engine consume the enriched environmental data that is stored in the digital trust infrastructure unit, wherein the digital trust infrastructure unit employs a blockchain for storing the enriched environmental data.

18. The data collection and processing system of claim 17, wherein the post-processing unit includes one or more software applications for processing and integrating the enriched environmental data stored in the blockchain to generate one or more reports from the enriched environmental data.

19. The data collection and processing system 17, wherein the post-processing unit further comprises a data visualization software application for analyzing the enriched environmental data and then displaying the data in a graph-type visualization format.

20. The data collection and processing system of claim 17, further comprising
a token creation unit for creating one or more tokens from the environmental data or the enriched environmental data collected from a plurality of measuring devices or the enriched environmental data or data provided by a third party to form one or more financial derivatives, wherein the financial derivatives can include one or more of a carbon credit, a renewable energy credit, an emissions reduction credit, and a carbon offset,
an attestation unit for verifying the environmental data forming the one or more tokens or the one or more tokens and for generating attestation data associated therewith, wherein the attestation data provides for a verification of the validity of the environmental data, and
a predictive analytics unit for analyzing the environmental data forming the one or more tokens and for providing predictions based on the environmental data.

21. The data collection and processing system of claim 17, wherein the post-processing unit further comprises one or more of:
an emissions accounting unit for processing the enriched environmental data to provide one or more reports related to tracking and determining emissions of an enterprise,
an emissions management unit for processing the enriched environmental data to manage the emissions of the enterprise,
an emissions reporting unit for processing the enriched environmental data to generate one or more reports directed to an emissions profile of the enterprise,
an emissions trading unit for processing the enriched environmental data to provide information relating to trading of one or more emission related credits between enterprises,
a risk management unit for processing the enriched environmental data to determine and manage a financial risk or a non-financial risk to the enterprise based on the environmental data, and
a governance reporting unit for processing the enriched environmental data and generating based thereon a report directed to a governance profile of the enterprise.

22. The data collection and processing system of claim 21, wherein the emissions accounting unit determines the emissions of the enterprise or building or infrastructure and determines and tracks energy consumption of the enterprise based on the enriched environmental data.

23. The data collection and processing system of claim 22, wherein the emissions management unit determines overall energy consumption of the enterprise and based on the enriched environmental data procures energy and one or more other utilities including water for the enterprise.

24. The data collection and processing system of claim 21, wherein the emissions reporting unit generates one or more reports based on climate data and the enriched environmental data to certify the accuracy of the emissions of the enterprise based on the emissions determined by the emissions accounting unit, the overall energy consumption determined by the emissions management unit, and one or more tokens created by a token creation unit from the environmental data collected from a plurality of measuring devices.

25. The data collection and processing system of claim 24, wherein the emissions trading unit is configured to determine a carbon allowance associated with the enterprise and to track and certify any tokenized carbon credits or renewable energy certificates or emissions reduction credits associated with the emission offsets of the enterprise.

26. A computer-implemented method for collecting and processing data, comprising
generating environmental data from a plurality of data sources,
providing a data analysis module for receiving the environmental data from the plurality of data sources, wherein the data analysis module includes
an enrichment unit for storing and enriching the environmental data from the plurality of data sources, wherein the enrichment unit includes a financial subsystem for analyzing and processing the environmental data and for generating financial data therefrom, and
a digital trust infrastructure unit for storing the financial data, the enriched environmental data or the environmental data stored in the data layer in a secure and verifiable format, and
processing the environmental data and the financial data stored in the digital trust infrastructure with a post-processing unit so as to generate one or more reports from the environmental data and the financial data,
wherein the enrichment layer is configured for
storing the environmental data from the plurality of data sources in a data layer, wherein the data layer is configured for
virtually segmenting the enterprise into a plurality of clusters with a partition unit, wherein each of the plurality of clusters has associated therewith one or more of the plurality of data sources for generating the environmental data, and
normalizing the environmental data from the plurality of data sources for each of the plurality of clusters with a normalization unit,
storing one or more software applications for processing the environmental data in the data layer in an application unit,
storing third party data that is related to the environmental data stored in the data layer in a third party data unit, and
applying one or more pre-defined techniques to the environmental data so as to process the environmental data in a cognitive intelligence unit.

27. The computer-implemented method of claim 26, wherein each of the plurality of clusters has one or more devices associated therewith, and wherein the one or more devices are configured to generate the environmental data and has one or more attributes associated therewith.

28. The computer-implemented method of claim 27, wherein the device comprises one or more sensors.

29. The computer-implemented method of claim 27, wherein virtually segmenting the enterprise comprises
determining based on the environmental data generated by the one or more devices a data attribute score associated with each device, wherein the data attribute score corresponds to the number of attributes associated with each device, and
ranking the devices based on the data attribute score.

30. The computer-implemented method of claim 29, wherein ranking the devices further comprises ranking the devices based on a reliability of the device.

31. The computer-implemented method of claim 30, wherein ranking the devices further comprises checking the reliability of the device by analyzing output data of the devices over a selected period of time and by comparing the output data to a preselected device output data range.

32. The computer-implemented method of claim 31, wherein ranking the devices further comprises determining the reliability of the device based on the output data generated by one or more additional devices.

33. The computer-implemented method of claim 32, wherein the plurality of data sources corresponds to a plurality of devices arranged in a device network, and wherein ranking the devices further comprises arranging each of the plurality of devices into a plurality of logical tiers based on a number of connections to the remaining devices in the device network.

34. The computer-implemented method of claim 33, further comprising normalizing the environmental data by contextualizing the environmental data associated with one or more clusters of the enterprise or one or more portions of one or more clusters of the enterprise.

35. The computer-implemented method of claim 34, wherein normalizing the environmental data comprises comparing the environmental data from one of the plurality of clusters with one or more other clusters of the plurality of clusters employing similar devices.

36. The computer-implemented method of claim 35, wherein normalizing the environmental data comprises
applying to the environmental data one or more rules associated with one or more standards associated with the environmental data so as to generate standards data, wherein the standards module applies the standard to the environmental data so as to estimate an emissions footprint of one or more clusters of the plurality of clusters, and
applying to the environmental data one or more rules associated with a selected framework that is associated with the environmental data being processed by the normalization unit so as to produce regulation data.

37. The computer-implemented method of claim 36, further comprising applying the standard to the environmental data to determine the emissions footprint of the total enterprise.

38. The computer-implemented method of claim 26, wherein each of the plurality of clusters has one or more devices associated therewith, and wherein the one or more devices are configured to generate the environmental data and has one or more attributes associated therewith, the method further comprising
determining an inventory of all of the devices in one or more of the plurality of clusters that are generating emissions,
verifying the environmental data from the devices using the attributes,
determining based on the environmental data generated by the one or more devices a data attribute score associated with each device, wherein the data attribute score corresponds to the number of attributes associated with each device,
ranking the devices and associated environmental data based on the data attribute score, and
normalizing the environmental data by contextualizing the environmental data associated with one or more clusters of the enterprise or one or more portions of one or more clusters of the enterprise.

39. The computer-implemented method of claim 38, further comprising
scoring the environmental data from one or more of the clusters by determining the number of attributes available in the cluster,
ranking the devices and associated environmental data based on the scoring, and
estimating the emissions of one or more of the clusters of the enterprise.

40. The computer-implemented method of claim 39, further comprising
recording non-environmental data and associated attribute data generated by one or more of the devices, and
verifying the non-environmental data with the attribute data.

41. The computer-implemented method of claim 40, further comprising
estimating the emissions of the cluster using the verified environmental data and the verified non-environmental data to form estimated emissions data,
normalizing the estimated emissions data by applying one or more of standards data associated with one or more standards and regulations data associated with one or more regulations to produce normalized emissions data,
allocating the normalized emissions data to one or more clusters of the enterprise enterprises or to one or more enterprises, and
determining the total emissions data associated with a first enterprise.

42. The computer-implemented method of claim 40, providing a smart contract stored in the digital trust infrastructure unit that is configured to:
estimate the emissions of the cluster using the verified environmental data and the verified non-environmental data to form estimated emissions data,
normalize the estimated emissions data by applying thereto one or more of standards data associated with one or more standards and regulations data associated with one or more regulations to produce normalized emissions data,
allocate the normalized emissions data to one or more clusters of the enterprise enterprises or to one or more enterprises, and
determine the total emissions data associated with a first enterprise.

43. The computer-implemented method of claim 42, further comprising
determining a net impact of a climate action taken by the first enterprise in response to the total emissions data, wherein each climate action has attribute data associated therewith,
recording the environmental data associated with each climate action taken by the first enterprise,
processing and recording the attribute data associated with each device and each climate action performed so as to verify the environmental data of each climate action of the first enterprise,
scoring the environmental data by determining a number of attributes forming the attribute data available in the first enterprise,
ranking the devices and the associated environmental information in the first enterprise based on the scoring of the attribute data for each climate action performed by the first enterprise,
recording non-environmental data and associated attribute data associated with each of the climate actions,
verifying the non-environmental data with the attribute data,
estimating a climate impact of the climate actions taken by the first enterprise based on the environmental data and the non-environmental data to generate estimated climate impact data,
normalizing the estimated climate impact data by applying thereto one or more of standards data associated with one or more standards and regulations data associated with one or more regulations to produce normalized climate impact data,
determining one or more financial and non-financial metrics associated with the normalized climate impact data for the first enterprise,
allocating the normalized climate impact data, and
estimating a nest impact of the climate actions taken by the first enterprise.

44. The computer-implemented method of claim 43, wherein the post-processing unit further comprises one or more of:
an emissions accounting unit for processing the enriched environmental data to provide one or more reports related to tracking and determining emissions of an enterprise,
an emissions management unit for processing the enriched environmental data to manage the emissions of the enterprise,
an emissions reporting unit for processing the enriched environmental data to generate one or more reports directed to an emissions profile of the enterprise,
an emissions trading unit for processing the enriched environmental data to provide information or reports related to trading of one or more emission related credits between enterprises,
a risk management unit for processing the enriched environmental data to determine and manage a financial risk to the enterprise based on the environmental data, and
a governance reporting unit for processing the enriched environmental data and generating based thereon a report directed to a governance profile of the enterprise.

45. The computer-implemented method of claim 39, further comprising recording a current status of a blockchain-implemented ledger using a modular smart contract.

46. The computer-implemented method of claim 45, further comprising
receiving, by a processing device, one or more new data object attributes and attribute values for an object key;
identifying, by the processing device, a data object matching the object key in the blockchain-implemented ledger;
storing, by the processing device executing a first modular contract from a transaction log partition of the block-chain implemented ledger, a first version of the data object associated with the object key in the block-chain implemented ledger, wherein the data object has a first version number and includes a first set of data object attributes and attribute values;
calling, by the processing device executing the first modular smart contract, a second smart contract from a validation data partition of the blockchain implemented ledger;
creating, by the processing device executing the second smart contract, a second version of the data object that is associated with the object key and that has a second version number;
importing, by the processing device executing the second smart contract, the first set of data object attributes and attribute values into the second version of the data object;
validating, by the processing device executing the second smart contract, the one or more new data object attributes and attribute values by retrieving validation rules from the validation data partition, applying the validation rules to a hierarchy associated with the one or more new data object attributes and attribute values, and determining that the hierarchy associated with the one or more new data object attributes and attribute values satisfies the validation rules;
submitting, by the processing device executing the second smart contract, the second version of the data object to the blockchain-implemented ledger that references the object key;
recording, by the processing device, a snapshot of the blockchain-implemented ledger holding the second version of the data object in a world state database; and
simultaneously retaining by the processing device, the first version of the data object and the second version of the data object in the blockchain transaction log partition.

47. The computer-implemented method of claim 46, wherein the one or more new data object attributes comprises a set of new private attributes and attribute values, as well as one or more shared attributes and attribute values.
